(19) United States
(12) Patent Application Publication
(10) Pub. No.: US 2014/0320761 A1
(43) Pub. Date: Oct. 30, 2014

(54) TOUCH PANEL AND DISPLAY APPARATUS

(71) Applicant: Katsunori Misaki, Yonago-shi (JP)

(72) Inventor: Katsunori Misaki, Yonago-shi (JP)

(73) Assignee: SHARP KABUSHIKI KAISHA, Osaka (JP)

(21) Appl. No.: 14/241,247

(22) PCT Filed: Aug. 30, 2012
(86) PCT No.: PCT/JP2012/072032

§ 371 Date: Feb. 26, 2014

(30) Foreign Application Priority Data
Sep. 2, 2011 (JP) 2011-191753

(51) Int. Cl. G06F 3/041

(52) U.S. Cl. CPC G06F 3/041
USPC 349/12

(57) ABSTRACT

A conductive protective layer (2) is provided that is formed in the same layer as a first bridge electrode (104A) on a layer above metal wiring (102) across an interlayer insulating film (103) so that the conductive protective layer overlaps the metal wiring (102) in a plan view. A touch panel having improved reliability can therefore be provided without increasing manufacturing unit price.

### TECHNICAL FIELD

The present invention relates to a touch panel and a display device including the touch panel.

### BACKGROUND ART

In recent years, in the area of mobile devices such as smartphones and mobile phones, display devices including touch panels having an input function in which a finger or an input stylus comes into contact with the display surface, which activates an operation selected based on the contact position, have become common.

Among touch panels included in such display devices, a resistive film-type (in which an input position is detected when an upper conductive substrate and a lower conductive substrate come into contact with each other when pressed) and a capacitive-type (in which an input position is detected by detecting a change in capacitance in a position that has been touched) have been the types mainly in use.

Among these, the capacitive-type has currently become the dominant type of touch panel due to the fact that a contact position can be detected with simple operations, and that multi-touch (in which a plurality of touch locations can be detected simultaneously) is possible with this type.

FIG. 34 shows one example of a capacitive-type touch panel, and shows, among capacitive-type touch panels, a schematic configuration of a single layer mutual capacitance-type touch panel 100 that is thin and has a high detection performance, in which drive electrode lines 101D and sensing electrode lines 101S are formed on the same plane.

As shown in the drawing, a touch detection region R1 on a substrate 106 includes diamond-shaped unit electrodes 101U adjacent to each other in the left and right direction in the drawing. A plurality of drive electrode lines 101D are aligned in the up and down direction in the drawing in parallel with each other, the drive electrode line 101D being constituted of the unit electrodes 101U that are electrically connected to each other through connecting portions 101C. The diamond-shaped unit electrodes 101U′ are disposed so as to be adjacent to each other in the up and down direction in the drawing. A plurality of sensing electrode lines 101S are aligned in the left and right direction in the drawing in parallel with each other, the sensing electrode lines 101S being constituted of the unit electrodes 101U′ that are electrically connected to each other through first bridge electrodes 104A.

The plurality of drive electrode lines 101D and the plurality of sensing electrode lines 101S are provided so as to be electrically separate from each other, and so as to intersect each other.

In the touch detection region R1 on the substrate 106, the unit electrodes 101U and the unit electrodes 101U′ are formed on the same plane adjacent to each other while not intersecting each other in a plan view.

In the touch panel 100, the unit electrodes 101U, the unit electrodes 101U′, the connecting portions 101C and the first bridge electrodes 104A are all made of ITO (indium tin oxide), which is a transparent electrode layer, and the unit electrodes 101U, the unit electrodes 101U′, and the connecting portions 101C are all formed on the same plane and of the same layer.

As shown, in portions where the plurality of drive electrode lines 101D intersect with the plurality of sensing electrode lines 101S, the first bridge electrodes 104A are respectively formed over the connecting portions 101C with the interlayer insulating film 103 therebetween, and thus, the plurality of drive electrode lines 101D and the plurality of sensing electrode lines 101S are electrically separate from each other.

On the other hand, as shown, in the vicinity of the touch detection region R1, a wiring line formation region R2 is provided, the wiring line formation region R2 being a region where the plurality of drive electrode lines 101D and the plurality of sensing electrode lines 101S are electrically connected to a plurality of terminal portions 101F through metal wiring lines 102.

The wiring line formation region R2 is provided with connecting electrodes 101E for electrically connecting the drive electrode lines 101D to the metal wiring lines 102, and relay electrodes 101G for electrically connecting the sensing electrode lines 101S to the metal wiring lines 102.

The connecting electrodes 101E, the relay electrodes 101G, and the terminal portions 101F are made of the same ITO layer as the unit electrodes 101U and 101U′ and the connecting portions 101C.

As shown, the connecting electrodes 101E connected to the drive electrode lines 101D and the terminal portions 101F are directly connected electrically to each other by the metal wiring lines 102, and thus, it is possible to electrically connect the drive electrode lines 101D to the terminal portions 101F.

On the other hand, the relay electrodes 101G, which are not electrically connected to the sensing electrode lines 101S, and the terminal portions 101F are directly connected electrically to each other by the metal wiring lines 102, and thus, it is possible to electrically connect the relay electrodes 101G to the terminal portions 101F. The electrical connection between the sensing electrode lines 101S and the relay electrodes 101G are made by second bridge electrodes 104B that are formed in the same layer as the first bridge electrodes 104A, through penetrating holes 102C in the metal wiring lines 102 formed on the relay electrodes 101G, and penetrating holes 103C in the interlayer insulating film 103 formed on the relay electrodes 101G and the metal wiring lines 102. Therefore, the sensing electrode lines 101S can be electrically connected to the terminal portions 101F.

When electrically connecting the sensing electrode wiring lines 101S to the terminal portions 101F through the metal wiring lines 102, a ground wiring line 102X that serves the function of performing shielding against electrical fields generated by external wiring lines extends in the left and right direction of the drawing in the touch detection region R1, and is provided in a portion closest to the sensing electrode lines 101S, and thus, the relay electrodes 101G are used for the electrical connection between the sensing electrode lines 101S and the terminal portions 101F.

FIG. 35(a) shows a cross-section of FIG. 34 along the line B1-B1′, FIG. 35(b) shows a cross-section of FIG. 34 along the line B2-B2′, and FIG. 35(c) shows a cross-section of FIG. 34 along the line B3-B3′.

FIG. 35(a) shows a portion where a drive electrode line 101D and a sensing electrode line 101S intersect, and an interlayer insulating film 103 is formed on a connecting portion 101C that connects adjacent unit electrodes 101U in the drive electrode line 101D, and by a first bridge electrode 104A formed on the interlayer insulating film 103, adjacent unit electrodes 101U′ in the sensing electrode line 101S are electrically connected to each other. A protective film 105 that is an organic layer is formed so as to cover the unit electrodes 101U′ and the first bridge electrode 104A.

FIG. 35(b) shows the wiring line formation region R2 in the vicinity of the terminal portion 101F; on the terminal portion 101F, which is formed of the same ITO layer as the unit electrode 101U, the unit electrode 101U′, and the connecting portion 101C, the metal wiring line 102 having a three-layer structure of MoNb/Al/MoNb is provided, and the interlayer insulating film 103 and the protective film 105, which are organic layers, are layered in that order so as to cover a portion of the metal wiring line 102 and the terminal portion 101F.

FIG. 35(c) shows the terminal portion 101F being formed on one end outside of the wiring line formation region R2, and the terminal portion 101F formed of the same ITO layer as the unit electrode 101U, the unit electrode 101U′, and the connecting portion 101C are exposed so as to be able to be connected electrically to external elements.

FIGS. 36(a) to 36(e) show manufacturing steps for the touch panel 100. FIG. 36(a) shows a step of forming the unit electrodes 101U, the unit electrodes 101U′, the connecting portions 101C, and the terminal portions 101F of the same ITO layer. FIG. 36(b) shows a step of forming the metal wiring lines 102. FIG. 36(c) shows a step of forming the interlayer insulating film 103. FIG. 36(d) shows a step of forming the first bridge electrode 104A. FIG. 36(e) shows a step of forming the protective film 105.

The touch panel 100 made in this manner is thin and has high detection performance.

### RELATED ART DOCUMENT

### Patent Document

Patent Document 1: Japanese Patent Application Laid-Open Publication No. 2004-317748 (published Nov. 11, 2004)

### SUMMARY OF THE INVENTION

### Problem to be Solved by the Invention

However, in the conventional touch panel 100 described above, as shown in FIGS. 35(b) and 36(e), the layers covering the metal wiring lines 102 are the interlayer insulating film 103 and the protective film 105, which are organic layers, which means that when the touch panel 100 is operated (with electricity flowing) in a hot and humid environment, moisture easily penetrates, which causes corrosion and deterioration of the metal wiring lines 102, resulting in reliability problems with the metal wiring lines 102.

In order to solve this problem, a possible solution is the configuration of FIG. 37 disclosed in Patent Document 1 above, in which an aluminum layer 150, a chromium layer 152, and a transparent inorganic oxide layer 154 are stacked in that order on an insulating substrate 211 so as to form a multilayer wiring structure, the chromium layer 152 being formed at a width (W2) that is at least the same as a width (W1) of the aluminum layer 150, a width (W3) of the transparent organic oxide layer 154 being at least the same as the width (W2) of the chromium layer 152.

However, in order to have such a multilayer wiring structure including the transparent inorganic oxide layer 154 as a protective layer, there is a need to have an additional step to form the transparent inorganic oxide layer 154 separately, which increases the number of steps to form the wiring lines, resulting in an increased manufacturing unit cost.

The present invention takes into account the above-mentioned situation, and an object thereof is to provide a touch panel with improved reliability without increased manufacturing unit cost, and a display device including such a touch panel.

### Means for Solving the Problems

In order to solve the above-mentioned problem, a touch panel of the present invention includes: a plurality of first electrodes aligned in a first direction and a plurality of second electrodes aligned in a second direction different from the first direction, the plurality of first electrodes and the plurality of second electrodes intersecting each other on an insulating substrate and being electrically connected to respective terminal portions through respective metal wiring lines, wherein the plurality of first electrodes and the plurality of second electrodes are electrically separate from each other, wherein the respective first electrodes and second electrodes are formed by having a plurality of unit electrodes of a prescribed shape electrically connected to each other, wherein the unit electrodes of the first electrodes and the unit electrodes of the second electrodes are formed on the same plane so as to be adjacent to each other without overlapping in a plan view, and wherein the touch panel further includes: first connecting portions that electrically connect adjacent unit electrodes in each of the first electrodes, the first connecting portions being formed in a layer different from that of the unit electrodes of the first electrodes and the unit electrodes of the second electrodes; second connecting portions that electrically connect adjacent unit electrodes in each of the second electrodes, the second connecting portions being formed in a layer different from that of the first connecting portions; an insulating layer provided between the first connecting portions and the second connecting portions at intersections between the first electrodes and the second electrodes, and provided so as to cover the metal wiring lines; and a conductive protective layer formed in a layer over the metal wiring lines across the insulating layer such that at least a portion thereof covers the metal wiring lines in a plan view, the conductive protective layer being formed of a layer by which the unit electrodes of the first electrodes are formed, a layer by which the unit electrodes of the second electrodes are formed, a layer by which the first connecting portions are formed, a layer by which the second connecting portions are formed, or a layer by which the terminal portions are formed.

According to the configuration above, a conductive protective layer is formed in a layer over the metal wiring lines across the insulating layer such that at least a portion thereof covers the metal wiring lines in a plan view, the conductive protective layer being formed of a layer by which the unit electrodes of the first electrodes are formed, a layer by which the unit electrodes of the second electrodes are formed, a layer by which the first connecting portions are formed, or a layer by which the second connecting portions are formed, and thus, the conductive protective layer prevents the entry of moisture, thus mitigating corrosion and deterioration of the metal wiring lines.

Thus, it is possible to attain a touch panel with improved reliability, without an increase in manufacturing unit price.

In order to solve the above-mentioned problem, a display device of the present invention includes the touch panel above and a display panel.

According to this configuration, it is possible to attain a display device including a touch panel with improved reliability without an increase in manufacturing unit price.

### Effects of the Invention

As stated above, in a touch panel according to the present invention, the plurality of first electrodes and the plurality of second electrodes are electrically separate from each other, the respective first electrodes and second electrodes are formed by having a plurality of unit electrodes of a prescribed shape electrically connected to each other, the unit electrodes of the first electrode and the unit electrodes of the second electrode are formed on the same plane so as to be adjacent to each other without overlapping in a plan view, and the touch panel further includes: first connecting portions that electrically connect adjacent unit electrodes in each of the first electrodes, the first connecting portions being formed in a layer different from that of the unit electrodes of the first electrodes and the unit electrodes of the second electrodes; second connecting portions that electrically connect adjacent unit electrodes in each of the second electrodes, the second connecting portions being formed in a layer different from that of the first connecting portions; an insulating layer provided between the first connecting portions and the second connecting portions at intersections between the first electrodes and the second electrodes so as to cover the metal wiring lines; and a conductive protective layer formed in a layer over the metal wiring lines across the insulating layer such that at least a portion thereof covers the metal wiring lines in a plan view, the conductive protective layer being formed of a layer by which the unit electrodes of the first electrodes are formed, a layer by which the unit electrodes of the second electrodes are formed, a layer by which the first connecting portions are formed, or a layer by which the second connecting portions are formed.

As described above, the display device of the present invention includes the touch panel and the display panel.

Thus, it is possible to attain a touch panel with improved reliability without an increase in manufacturing unit cost, and a display device including such a touch panel.

### BRIEF DESCRIPTION OF THE DRAWINGS

FIG. 1 shows a schematic configuration of a touch panel according to an embodiment of the present invention.

FIG. 2 shows cross-sectional views of the touch panel according to the embodiment of the present invention shown in FIG. 1.

FIG. 3 shows manufacturing steps for the touch panel according to the embodiment of the present invention shown in FIG. 1.

FIG. 4 shows a schematic configuration of a touch panel according to another embodiment of the present invention.

FIG. 5 shows cross-sectional views of the touch panel according to the embodiment of the present invention shown in FIG. 4.

FIG. 6 shows manufacturing steps for the touch panel according to the embodiment of the present invention shown in FIG. 4.

FIG. 7 shows a schematic configuration of a touch panel according to another embodiment of the present invention.

FIG. 8 shows a schematic configuration of a touch panel according to another embodiment of the present invention.

FIG. 9 shows cross-sectional views of the touch panel according to the embodiment of the present invention shown in FIG. 8.

FIG. 10 shows manufacturing steps for the touch panel according to the embodiment of the present invention shown in FIG. 8.

FIG. 11 shows a cover glass included in a conventional touch panel.

FIG. 12 is a drawing for describing conventional manufacturing steps for the cover glass shown in FIG. 11.

FIG. 13 is a schematic configuration of a touch panel according to another embodiment of the present invention.

FIG. 14 shows cross-sectional views of the touch panel according to the embodiment of the present invention shown in FIG. 13.

FIG. 15 shows manufacturing steps for the touch panel according to the embodiment of the present invention shown in FIG. 13.

FIG. 16 shows manufacturing steps for the touch panel according to the embodiment of the present invention shown in FIG. 13.

FIG. 17 shows a modification example of the touch panel according to the embodiment of the present invention shown in FIG. 13.

FIG. 18 shows a schematic configuration of a touch panel according to another embodiment of the present invention.

FIG. 19 shows cross-sectional views of the touch panel according to the embodiment of the present invention shown in FIG. 18.

FIG. 20 shows manufacturing steps for the touch panel according to the embodiment of the present invention shown in FIG. 18.

FIG. 21 shows an example of a 2D liquid crystal display device including a touch panel of an embodiment of the present invention.

FIG. 22 shows an example of manufacturing steps for the 2D liquid crystal display device including the touch panel shown in FIG. 21.

FIG. 23 shows an example of manufacturing steps for a 2D liquid crystal display device including the touch panel shown in FIG. 21 that has been thinned.

FIG. 24 shows an example of a liquid crystal display device including an on-cell type touch panel of an embodiment of the present invention.

FIG. 25 shows an example of manufacturing steps for the liquid crystal display device including the on-cell type touch panel shown in FIG. 24.

FIG. 26 shows an example of manufacturing steps for a liquid crystal display device including the on-cell type touch panel shown in FIG. 24 that has been thinned.

FIG. 27 shows another example of manufacturing steps for a liquid crystal display device including the on-cell type touch panel shown in FIG. 24.

FIG. 28 shows another example of manufacturing steps for a liquid crystal display device including the on-cell type touch panel shown in FIG. 24 that has been thinned.

FIG. 29 shows an example of a 3D liquid crystal display device including a touch panel of an embodiment of the present invention.

FIG. 30 shows an example of manufacturing steps for the 3D liquid crystal display device including the touch panel shown in FIG. 29.

FIG. 31 shows an example of manufacturing steps for a 3D liquid crystal display device including the touch panel shown in FIG. 29 that has been thinned.

FIG. 32 shows another example of manufacturing steps for the 3D liquid crystal display device including the touch panel shown in FIG. 29.

FIG. 33 shows another example of manufacturing steps for a 3D liquid crystal display device including the touch panel shown in FIG. 29 that has been thinned.

FIG. 34 is a drawing showing an example of a conventional capacitive type touch panel.

FIG. 35 shows cross-sectional views of the conventional capacitive type touch panel shown in FIG. 34.

FIG. 36 shows manufacturing steps for the conventional capacitive type touch panel shown in FIG. 34.

FIG. 37 shows a multilayer wiring line structure disclosed in Patent Document 1.

### DETAILED DESCRIPTION OF EMBODIMENTS

Below, embodiments of the present invention will be explained in detail with reference to figures. However, dimensions, materials, shapes, positional relationships, and the like of constituting members described in these embodiments are merely individual embodiment examples, and the scope of the present invention shall not be narrowly interpreted by being limited thereto.

### Embodiment 1

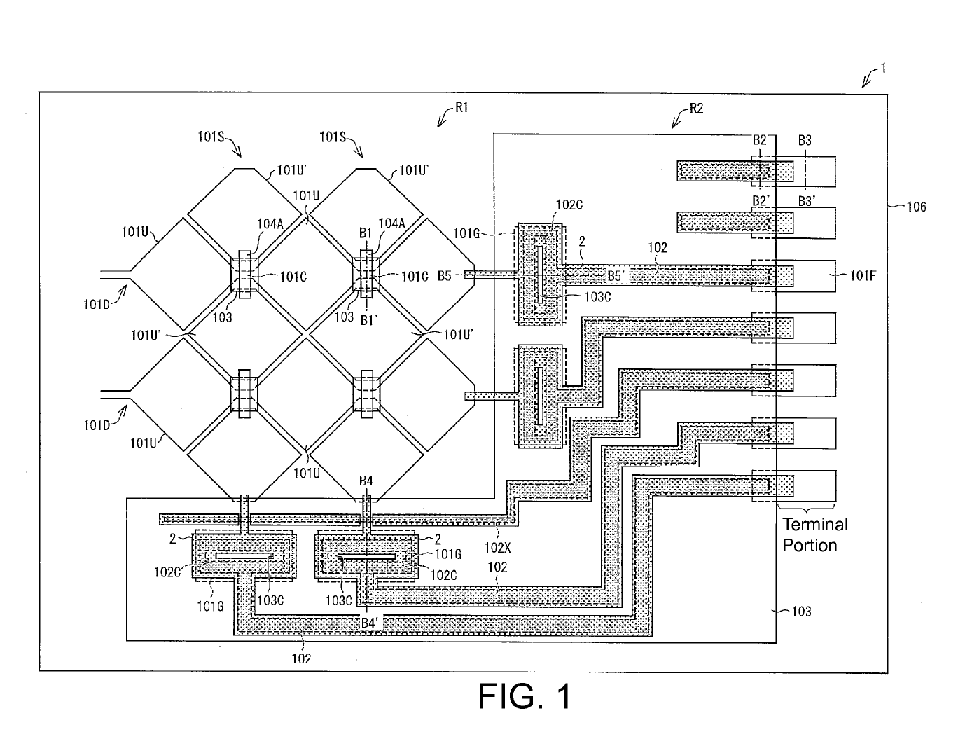

Below, Embodiment 1 of the present invention will be explained in detail with reference to FIGS. 1 to 3.

FIG. 1 shows a schematic configuration of a touch panel 1.

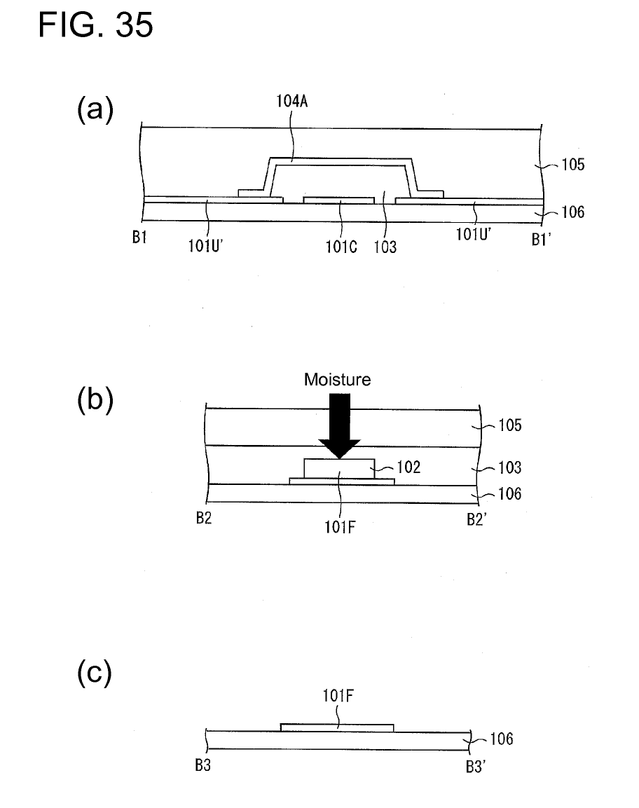

The touch panel 1 of FIG. 1 differs from the conventional touch panel 100, shown in FIGS. 34 to 36, described above only in that conductive protective layers 2 formed in the same layer as first bridge electrodes 104A so as to cover metal wiring lines 102 across an interlayer insulating film 103 in a wiring line formation region R2 are provided, and other aspects are the same as what was described in the touch panel 100. For ease of description, members that have the same functions as members shown in drawings of the touch panel 100 will be assigned the same reference characters, and descriptions thereof will be omitted.

As shown, in the touch panel 1, the configuration of the touch panel 100 shown in FIG. 34 is used in order to electrically connect the sensing electrode lines 101S and the relay electrodes 101G to each other, thereby electrically connecting the sensing electrode lines 101S and the drive electrode lines 101D to the terminal portions 101F.

The conventional touch panel 100 shown in FIG. 34 has a configuration in which the sensing electrode lines 101S and the terminal portions 101F are electrically connected by the second bridge electrodes 104B, which are formed in the same layer as the first bridge electrodes 104A, through the penetrating holes 102C in the metal wiring lines 102 formed on the relay electrodes 101G and the penetrating holes 103C in the interlayer insulating film 103 formed on the relay electrodes 101G and the metal wiring lines 102. The touch panel 1 shown in FIG. 1 differs therefrom in that conductive protective layers 2 made of the same layer as the first bridge electrodes 104A are provided instead of the second bridge electrodes 104B, and in that the conductive protective layers 2 have the double function of fulfilling the role of the second bridge electrodes 104B in FIG. 34 and protecting the metal wiring lines 102.

In the conventional touch panel 100 shown in FIG. 34, if the configuration uses relay electrodes 101G, the second bridge electrodes 104B are used to electrically connect the sensing electrode lines 101S to the relay electrodes 101G. However, in the touch panel 1 of the present embodiment, it is possible to electrically connect the drive electrode lines 101D or sensing electrode lines 101S to the relay electrodes 101G through the conductive protective layers 2, and thus, it is possible to provide the conductive protective layers 2 that can mitigate the entrance of moisture with ease to improve the reliability of the metal wiring lines 102 without an increase in the number of manufacturing steps compared to that of the conventional touch panel 100.

Also, as shown, the grounding wiring line 102X differs from other metal wiring lines 102 in that they do not need to be electrically connected to the drive electrode lines 101D and sensing electrode lines 101S, and thus, the shape of the conductive protective layer 2 formed over the ground wiring line 102X differs from the conductive protective layers 2 formed over other metal wiring lines 102.

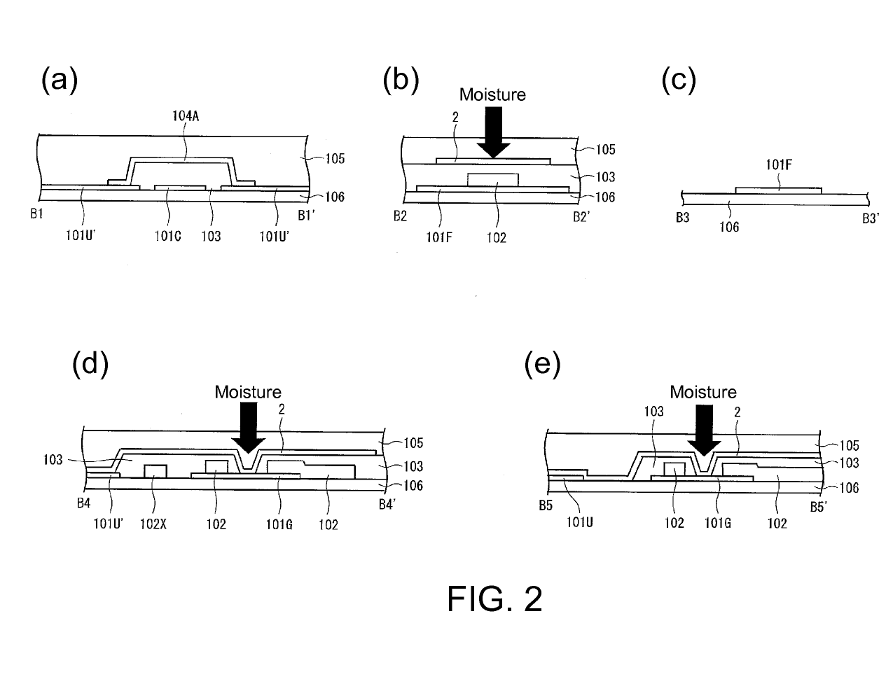

FIG. 2 shows cross-sectional views of the touch panel 1 shown in FIG. 1. FIG. 2(a) is a cross-section of FIG. 1 along the line B1-B1′, FIG. 2(b) is a cross-section of FIG. 1 along the line B2-B2′, FIG. 2(c) is a cross-section of FIG. 1 along the line B3-B3′, FIG. 2(d) is a cross-section of FIG. 1 along the line B4-B4′, and FIG. 2(e) is a cross-section of FIG. 1 along the line B5-B5′.

FIG. 2(a) shows an intersection between a drive electrode line 101D and a sensing electrode line 101S; on the connecting portion 101C connecting adjacent unit electrodes 101U of the drive electrode line 101D, an interlayer insulating film 103 is formed, and the first bridge electrode 104A formed on the interlayer insulating film 103 allows adjacent unit electrodes 101U′ of the sensing electrode line 101S to be electrically connected. An organic protective layer 105 is formed so as to cover the unit electrodes 101U′ and the first bridge electrodes 104A.

FIG. 2(b) shows the wiring line formation region R2 in the vicinity of the terminal portions 101F; metal wiring lines 102 that have a three-layer structure constituted of MoNb/Al/MoNB are provided on the terminal portions 101F made of the same ITO layer as the unit electrodes 101U, the unit electrodes 101U′, and the connecting portions 101C, and an interlayer insulating film 103 that is an organic layer is provided so as to cover a portion of the metal wiring lines 102 and the terminal portions 101F.

On the interlayer insulating film 103, conductive protective layers 2 made of the same layer as the first bridge electrodes 104A are formed so as to cover the metal wiring lines 102 in a plan view.

In the present embodiment, as shown in FIG. 1, the conductive protective layer 2 and the metal wiring line 102 overlap completely in a plan view, taking into account the protective efficiency by the conductive protective layer 2 for the metal wiring line 102, but the configuration is not limited thereto, and protective effects can be attained even if the conductive protective layer 2 and the metal wiring line 102 only partially overlap in a plan view.

Then the organic protective film 105 is formed so as to cover the conductive protective layer 2 and the interlayer insulating film 3.

FIG. 2(c) shows a terminal portion 101F formed on one end of the outside of the wiring line formation region R2, and the terminal portions 101F that are made of the same ITO layer as the unit electrodes 101U, the unit electrodes 101U′, and the connecting portions 101C are exposed so as to be electrically connected to external elements.

FIG. 2(d) shows a portion in which a sensing electrode line 101S, a relay electrode 101G, and a metal wiring line 102 are electrically connected by a conductive protective layer 2.

As shown, first, the unit electrode 101U′ of the sensing electrode line 101S and the relay electrode 101G made of the same layer are formed on the substrate 106. The ground wiring line 102X is formed between the unit electrode 101U′ and the relay electrode 101G, and the metal wiring line 102 is formed to be in contact with the relay electrode 101G.

The ground wiring line 102X and the metal wiring line 102 are made of the same layer, and the metal wiring line 102 has a contact hole formed therein over the relay electrode 101G. The interlayer insulating film 103 is formed so as to cover a portion of the unit electrode 101U′, the relay electrode 101G, the ground wiring line 102X, and the metal wiring lines 102.

A contact hole is formed in the interlayer insulating film 103 so as to correspond in position to the contact hole formed in the metal wiring line 102 in a plan view.

Then, the unit electrode 101U′ and the relay electrode 101G are electrically connected to each other by the conductive protective layer 2, and the ground wiring line 102X and the metal wiring line 102 are protected.

The protective film 105 is formed so as to cover the conductive protective layer 2 and the interlayer insulating film 103.

FIG. 2(e) shows a portion in which a drive electrode line 101D, a relay electrode 101G, and a metal wiring line 102 are electrically connected by a conductive protective layer 2.

As shown, first, the unit electrode 101U of the drive electrode line 101D and the relay electrode 101G made of the same layer are formed on the substrate 106. The metal wiring line 102 is formed to be in contact with the relay electrode 101G, and the metal wiring line 102 has formed therein a contact hole over the relay electrode 101G.

Then, the interlayer insulating film 103 is formed so as to cover the relay electrode 101G and the metal wiring line 102, and a contact hole is formed in the interlayer insulating film 103 so as to correspond in position to the contact hole formed in the metal wiring line 102 in a plan view.

Then, the unit electrode 101U and the relay electrode 101G are electrically connected and the metal wiring line 102 is protected as a result of the conductive protective layer 2.

The protective film 105 is formed so as to cover the conductive protective layer 2 and the interlayer insulating film 103.

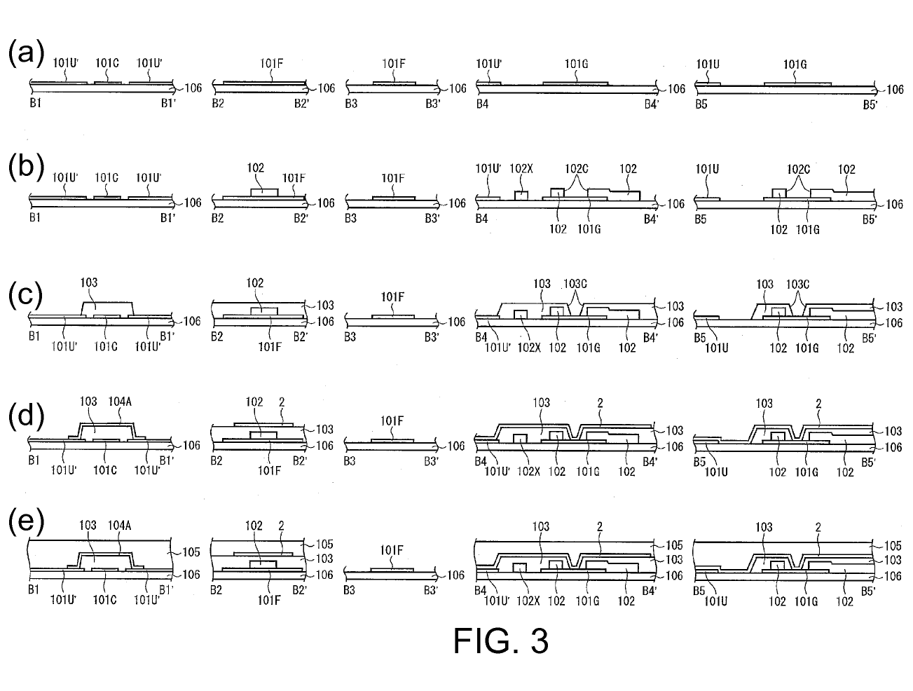

FIGS. 3(a) to 3(e) show manufacturing steps for the above-mentioned touch panel 1. FIG. 3(a) shows a step of forming the unit electrodes 101U and 101U′, the connecting portions 101C, the relay electrodes 101G, and the terminal portions 101F of the same ITO layer, FIG. 3(b) shows a step of forming the metal wiring lines 102 and the ground wiring line 102X made of the same layer, FIG. 3(c) shows a step of forming the interlayer insulating film 103, FIG. 3(d) shows a step of forming the first bridge electrodes 104A and the conductive protective layers 2 made of the same layer as the first bridge electrodes 104A, and FIG. 3(e) shows a step of forming the protective film 105.

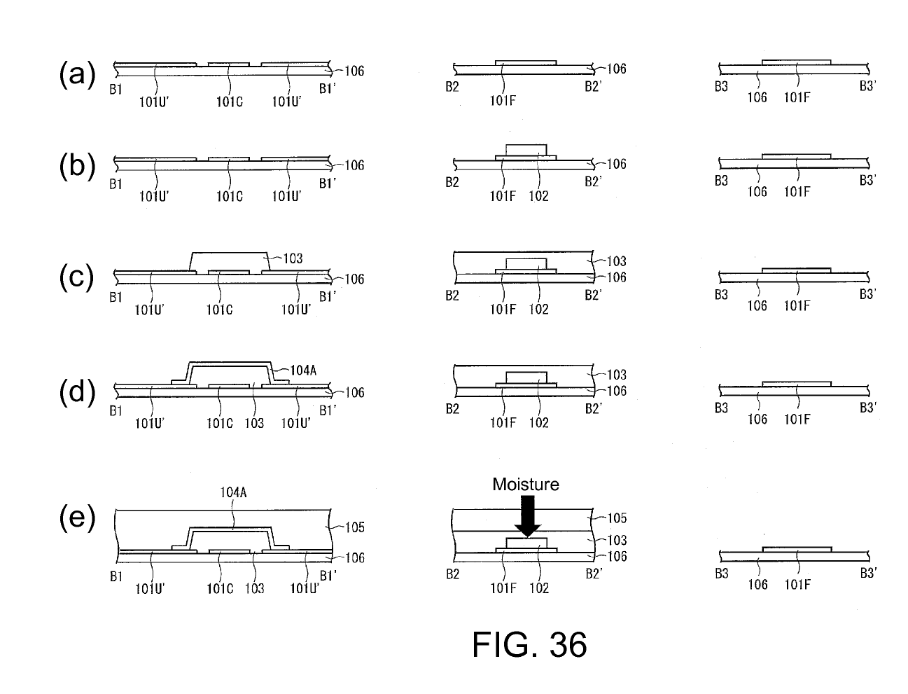

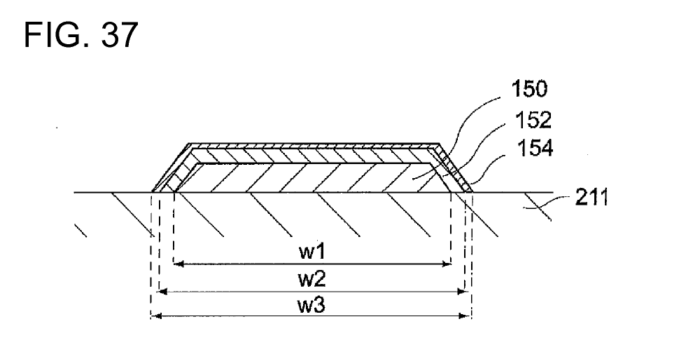

As shown, the manufacturing steps for the touch panel 1 can be performed with five mask steps, and thus, despite the inclusion of the conductive protective layers 2, the number of manufacturing steps is not greater than the number of manufacturing steps for the conventional touch panel 100 shown in FIG. 36.

The principles behind the driving of the touch panel 1 will be described below with reference to FIG. 1.

As shown, the unit electrodes 101U of the drive electrode lines 101D and the unit electrodes 101U′ of the sensing electrode lines 101S are formed so as to be adjacent to each other in the touch detection region R1. A capacitance C_{F} is formed between the adjacent unit electrodes 101U and 101U′, and this capacitance C_{F} differs depending on whether or not an object to be detected such as a finger or a stylus is in contact. The capacitance when the object is in not in contact is greater than the capacitance when the object is in contact (C_{F}_{_{—}}_{untouch}>C_{F}_{_{—}}_{touch}). The touch position can be detected based on this principle.

A signal having a prescribed waveform is sequentially inputted from the terminal portions 101F electrically connected to the drive electrode lines 101D, and detection signals are outputted from the terminal portions 101F electrically connected to the sensing electrode lines 101S.

In the present embodiment, in order to minimize the visual presence of the first bridge electrodes 104A in the touch detection region R1, the first bridge electrodes 104A and the conductive protective layer 2 were made of an ITO layer, which is a transparent conductive layer, but the material is not limited thereto, and IZO (indium zinc oxide), which is another type of transparent conductive film may be used, and further, it is possible to use a metal material such as a low-resistance metal including titanium (Ti), copper (Cu), gold (Au), aluminum (Al), tungsten (W), zinc (Zn), nickel (Ni), tin (Sn), chromium (Cr), molybdenum (Mo), and tantalum (Ta), or a metal compound or metal silicide thereof, for example.

In the present embodiment, unit electrodes 101U of the drive electrode lines 101D, the unit electrodes 101U′ of the sensing electrode lines 101S, the connecting portions 101C, and the terminal portions 101F are made of the same layer, and thus, the conductive protective layer 2 was formed using the layer used to form the first bridge electrodes 104A, but the configuration is not limited thereto.

Also, if the unit electrodes 101U of the drive electrode lines 101D, the unit electrodes 101U′ of the sensing electrode lines 101S, the connecting portions 101C, and the terminal portions 101F are not formed of the same layer, then if they can be formed over the metal wiring lines 102 across the interlayer insulating film 103, it is also possible to form the conductive protective layers 2 using the layer to form the unit electrodes 101U of the drive electrode lines 101D, the layer to form the unit electrodes 101U′ of the sensing electrode lines 101S, the layer to form the terminal portions 101F, and the layer to form the connecting portions 101C.

In the present embodiment, the tapered shape of the metal wiring lines 102 need not be a sequential tapered shape, and the tapered shape of the metal wiring lines 102 has no specific limitation. Therefore, while an organic insulating layer made of an acrylic organic material was used as the interlayer insulating film 103, for example, the material is not limited thereto.

### Embodiment 2

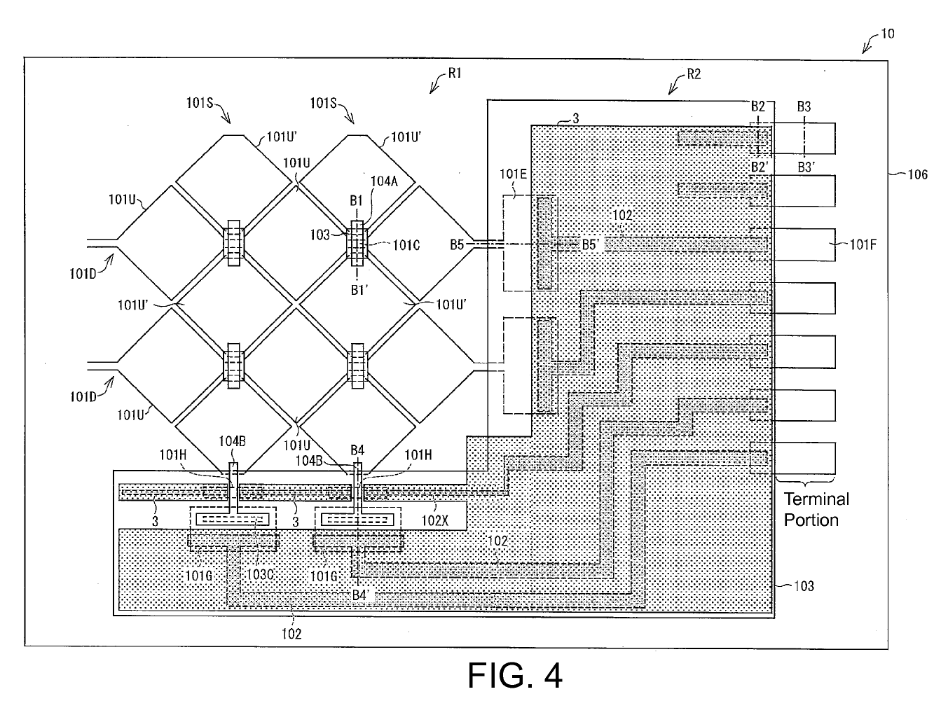

Embodiment 2 of the present invention will be described with reference to FIGS. 4 to 6. In the touch panel 1 of Embodiment 1, the conductive protective layers 2 were formed so as to individually cover the metal wiring lines 102, but a touch panel 10 of the present embodiment differs from Embodiment 1 in that a conductive protective layer 3 is formed so as to cover all of a plurality of metal wiring lines 102. Other configurations are as described in Embodiment 1. For ease of description, members that have the same functions as members shown in drawings of Embodiment 1 will be assigned the same reference characters, and descriptions thereof will be omitted.

FIG. 4 shows a schematic configuration of the touch panel 10.

As described above, the conductive protective layers 2 of the touch panel 1 shown in FIG. 1 had the double-role of functioning as the second bridge electrodes 104B and protecting the metal wiring lines 102, and thus, there was a need to provide individual conductive protective layers 2 for the respective metal wiring lines 102.

However, in the touch panel 10 of the present embodiment, the drive electrode lines 101D and the metal wiring lines 102 are electrically connected directly by connecting electrodes 101E connected to the drive electrode lines 101D, while the sensing electrode lines 101S and the metal wiring lines 102 are electrically connected by separately provided second bridge electrodes 104B through relay electrodes 101G.

Thus, the conductive protective layer 3 provided on the touch panel 10 does not need to fulfill the role of the second bridge electrode 104B, and therefore, as shown, can be formed so as to cover all of the plurality of metal wiring lines 102.

Also, as shown, in order to completely cover the ground wiring lines 102X, separate conductive protective layers 3 need to be provided in addition to the conductive protective layer 3 formed so as to cover all of the metal wiring lines 102.

In such a touch panel 10 in which the conductive protective layer 3 covers all of the plurality of metal wiring lines 102, it is possible to protect more reliably the metal wiring lines 102 compared to the touch panel 1 described in Embodiment 1.

Also, as shown, in portions where the second bridge electrodes 104B formed of the same layer as the conductive protective layer 3 intersects with the ground wiring lines 102X, it is not possible to form the conductive protective layer 3 over the ground wiring lines 102X, and thus, in such portions, respective ground wiring lines 102X are electrically connected to each other by the unit electrodes 101U and 101U′, the connecting portions 101C, connecting electrodes 101E, terminal portions 101F, relay electrodes 101G, and ground wiring line connecting electrodes 101H formed of the same layer.

In other words, in the present embodiment, the ground wiring line connecting electrodes 101H are made of an ITO layer, and thus, even if the conductive protective layer 3 is not provided thereabove, the ground wiring line connecting electrodes 101H are not susceptible to corrosion or deterioration, and thus, are not susceptible to problems of reliability.

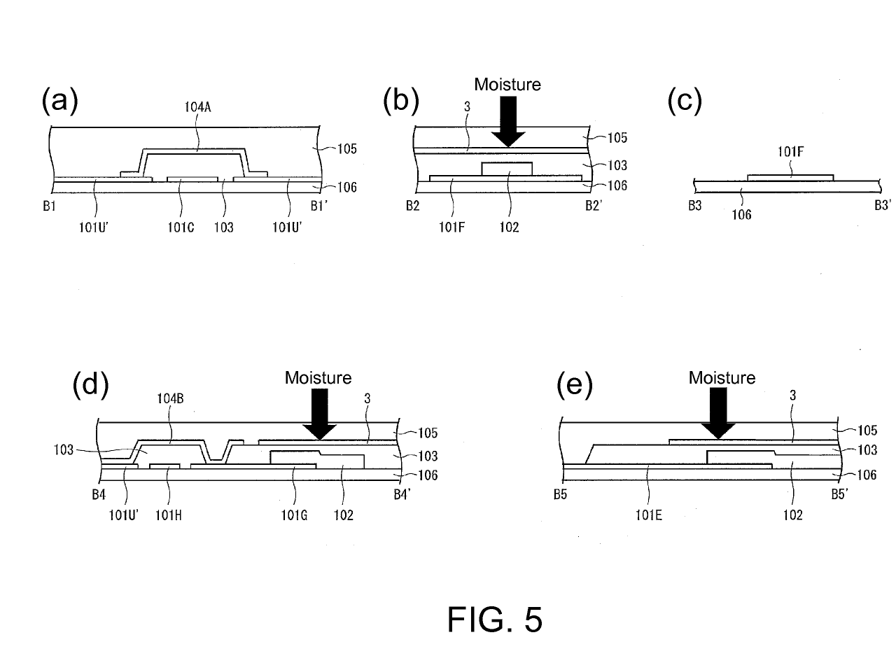

FIG. 5 shows cross-sectional views of the touch panel 10 of FIG. 4. FIG. 5(a) shows a cross-section of FIG. 4 along the line B1-B1′, FIG. 5(b) shows a cross-section of FIG. 4 along the line B2-B2′, FIG. 5(c) shows a cross-section of FIG. 4 along the line B3-B3′, FIG. 5(d) shows a cross-section of FIG. 4 along the line B4-B4′, and FIG. 5(e) shows a cross-section of FIG. 4 along the line B5-B5′.

FIG. 5(a) is similar to FIG. 2(a) and therefore, descriptions thereof will be omitted.

FIG. 5(b) shows a wiring line formation region R2 in the vicinity of the terminal portions 101F, and metal wiring lines 102 having a three-layer structure constituted of MoNb/Al/MoNb are provided on the terminal portions 101F made of the same ITO layer as the unit electrodes 101U, the unit electrodes 101U′, and the connecting portions 101C, and an interlayer insulating film 103 that is an organic layer is provided so as to cover portions of the metal wiring lines 102 and the terminal portions 101F.

On the interlayer insulating film 103, a conductive protective layer 3 made of the same layer as the first bridge electrodes 104A and formed so as to cover all of the plurality of metal wiring lines 102 is provided so as to cover the metal wiring lines 102 in a plan view.

The protective film 105 that is an organic layer is formed so as to cover the conductive protective layer 3.

FIG. 5(c) is also similar to FIG. 2(c) and therefore, descriptions thereof will be omitted.

FIG. 5(d) shows where the unit electrode 101U′ of the sensing electrode line 101S, the relay electrode 101G, and the metal wiring line 102 are electrically connected by the second bridge electrode 104B, and where the conductive protective layer 3 is provided over the metal wiring line 102.

As shown, first, the unit electrode 101U′ of the sensing electrode line 101S, the relay electrode 101G, and the ground wiring line connecting electrode 101H made of the same layer are formed on the substrate 106. The ground wiring line connecting electrode 101H that electrically connects ground wiring lines 102X (not shown) is provided between the unit electrode 101U′ and the relay electrode 101G.

The ground wiring lines 102X (not shown) and the metal wiring lines 102 are formed of the same layer, and the metal wiring lines 102 are formed so as to be in contact with the relay electrodes 101G. The interlayer insulating film 103 is formed so as to cover a portion of the unit electrode 101U′, the ground wiring line connecting electrode 101H, the relay electrode 101G, and the metal wiring line 102.

Also, contact holes are formed in the interlayer insulating film 103 over the relay electrodes 101G where the metal wiring lines 102 are not formed.

Then, the unit electrode 101U′ and the relay electrode 101G are electrically connected by the second bridge electrode 104B, and the metal wiring line 102 is protected by the conductive protective layer 3 formed in the same layer as the second bridge electrode 104B.

The protective film 105 is formed so as to cover the conductive protective layer 3, the second bridge electrode 104B, and the interlayer insulating film 103.

FIG. 5(e) shows a portion where the connecting electrode 101E connected to the drive electrode line 101D is electrically connected to the metal wiring line 102.

As shown, first, the connecting electrode 101E is formed on the substrate 106, the connecting electrode 101E being formed of the same layer as the unit electrode 101U (not shown) of the drive electrode line 101D, and being connected to the drive electrode line 101D.

Then the metal wiring line 102 is formed to be in contact with the connecting electrode 101E, and the interlayer insulating film 103 is formed to cover a portion of the connecting electrode 101E and the metal wiring line 102.

The conductive protective layer 3 having a shape that covers all of the plurality of metal wiring lines 102 is provided on the interlayer insulating film 103 so as to cover the metal wiring lines 102 in a plan view.

The protective film 105 is formed so as to cover the conductive protective layer 3, the connecting electrode 101E, and the interlayer insulating film 103.

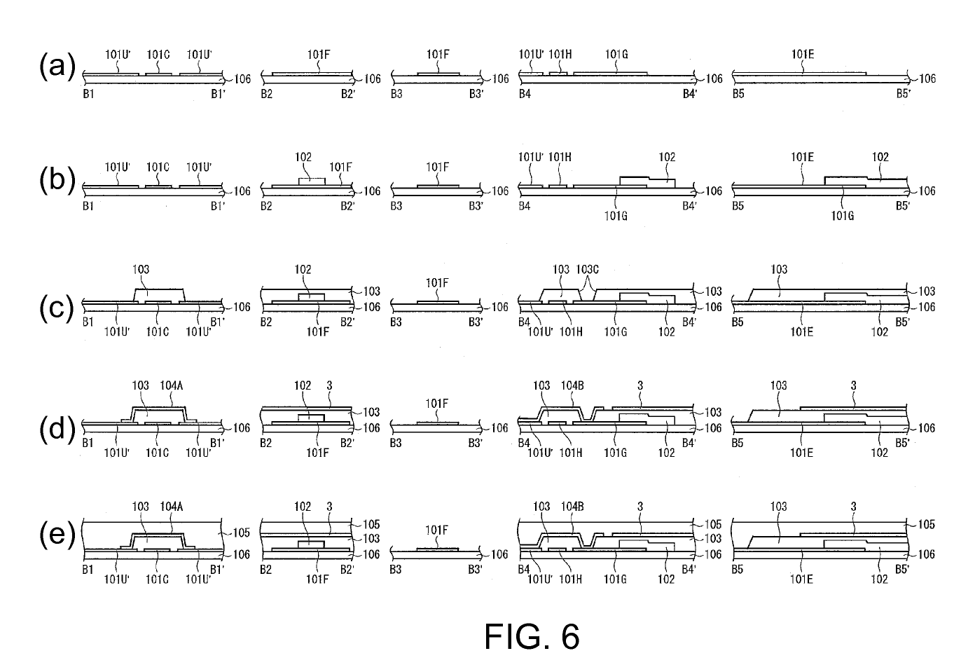

FIGS. 6(a) to 6(e) show manufacturing steps for the touch panel 10 described above. FIG. 6(a) shows a step of forming the unit electrodes 101U and 101U′, the connecting portion 101C, the ground wiring line connecting electrode 101H, the connecting electrode 101E, and the terminal portion 101F of the same ITO layer, FIG. 6(b) shows a step of forming the metal wiring line 102, FIG. 6(c) shows a step of forming the interlayer insulating film 103, FIG. 6(d) shows a step of forming a first bridge electrode 104A, and a conductive protective layer 3 and second bridge electrode 104B formed of the same layer as the first bridge electrode 104A, and FIG. 6(e) shows a step of forming the protective film 105.

As shown, the manufacturing steps for the touch panel 10 can be performed with five mask steps, and thus, despite the inclusion of the conductive protective layer 3 formed so as to cover all of the plurality of metal wiring lines 102, the number of manufacturing steps is not greater than the number of manufacturing steps for the conventional touch panel 100 shown in FIG. 36.

### Embodiment 3

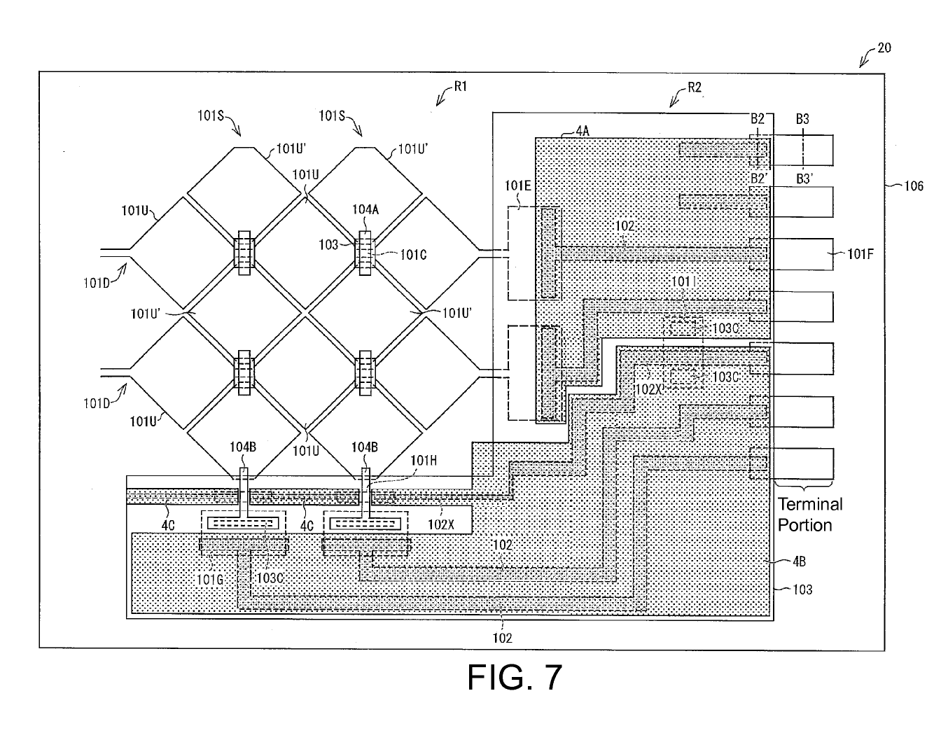

Embodiment 3 of the present invention will be described with reference to FIG. 7. The touch panel 10 of Embodiment 2 was formed such that the conductive protective layer 3 covers all of the plurality of metal wiring lines 102, but a touch panel 20 of the present embodiment differs from Embodiment 2 in that the conductive protective layers include a conductive protective layer 4A that covers metal wiring lines 102 connected to the drive electrode lines 101D, and a separately formed conductive protective layer 4B that covers metal wiring lines 102 connected to the sensing electrode lines 101S, but other aspects are the same as those described in Embodiment 1. For ease of description, members that have the same functions as members shown in drawings of Embodiment 1 will be assigned the same reference characters, and descriptions thereof will be omitted.

FIG. 7 shows a schematic configuration of the touch panel 20.

As shown, the conductive protective layers included in the touch panel 20 include the conductive protective layer 4A that covers the metal wiring lines 102 connected to the drive electrode lines 101D, and a separately formed the conductive protective layer 4B covering the metal wiring lines 102 connected to the sensing electrode lines 101S.

A connecting electrode 101I formed of the same layer as the unit electrodes 101U and 101U′ and the connecting portions 101C are electrically connected to the ground wiring line 102X so as to overlap both the conductive protective layer 4A and the conductive protective layer 4B.

Then, the conductive protective layer 4A and the conductive protective layer 4B are electrically connected to the ground wiring line 102X through two contact holes 103C in the interlayer insulating film 103 formed over the connecting electrode 101I, which allows both the conductive protective layer 4A and the conductive protective layer 4B to be grounded.

Using such a configuration, it is possible to attain a touch panel 20 with improved capacitive touch functionality.

### Embodiment 4

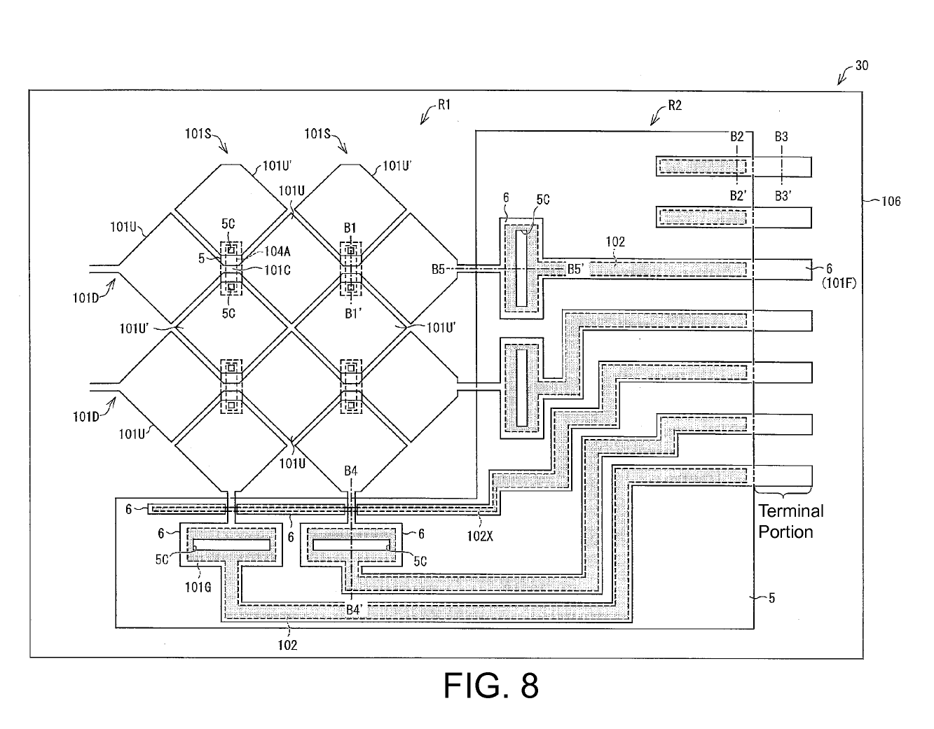

Embodiment 4 of the present invention will be described with reference to FIGS. 8 to 10. A touch panel 30 of the present embodiment differs from Embodiments 1 to 3 in that a low resistance metal layer that is the same layer as metal wiring lines 102 is used as the layer in which first bridge electrodes 104A are formed, in that an interlayer insulating layer 5 made of black resin, for example, which absorbs visible light, is used, and in that conductive protective layers 6 made of the same layer as the unit electrodes 101U and 101U′ and connecting portions 101C are used. Other aspects are as described in Embodiments 1 to 3. For ease of description, members that have the same functions as members shown in drawings of Embodiments 1 to 3 will be assigned the same reference characters, and descriptions thereof will be omitted.

FIG. 8 shows a schematic configuration of the touch panel 30.

As shown, in a touch detection region R1, first bridge electrodes 104A made of a low resistance metal layer that is the same layer as that of the metal wiring lines 102 are at the bottommost layer, and in the present embodiment, the first bridge electrodes 104A have, as the low-resistance metal layer, a three-layer structure constituted of MoNb/Al/MoNb, but the low-resistance metal layer is not limited thereto.

In the touch detection region R1, an interlayer insulating layer 5 made of a black resin, for example, that absorbs visible light is provided on the first bridge electrodes 104A in order to prevent the pattern of the first bridge electrodes 104A made of a metal layer from being seen.

Adjacent unit electrodes 101U′ in the sensing electrode line 101S are electrically connected to each other through contact holes 5C in the interlayer insulating layer 5 formed on the first bridge electrodes 104A.

On the other hand, adjacent unit electrodes 101U in the drive electrode line 101D are electrically connected to each other through a connecting portion 101C formed on the interlayer insulating layer 5.

It is preferable that the first bridge electrodes 104A be narrower in width than the interlayer insulating layer 5, and that the width of the interlayer insulating layer 5 be at most 20 μm.

On the other hand, in a wiring line formation region R2, the metal wiring lines 102 are formed as the bottommost layer that is the same layer as the first bridge electrodes 104A, and conductive protective layers 6 formed of the same layer as the unit electrodes 101U and 101U′ and the connecting portions 101C are provided so as to individually cover the metal wiring lines 102 across the interlayer insulating layer 5.

The conductive protective layers 6 are connected to the drive electrode lines 101D and the sensing electrode lines 101S, and ends of the conductive protective layers 6 are terminal portions 101F.

The conductive protective layers 6 are made of an ITO layer that is a transparent conductive layer with a relatively high resistance, and therefore, are electrically connected to the metal wiring lines 102 through the contact holes 5C formed in the interlayer insulating layer 5 in order to lower the resistance thereof.

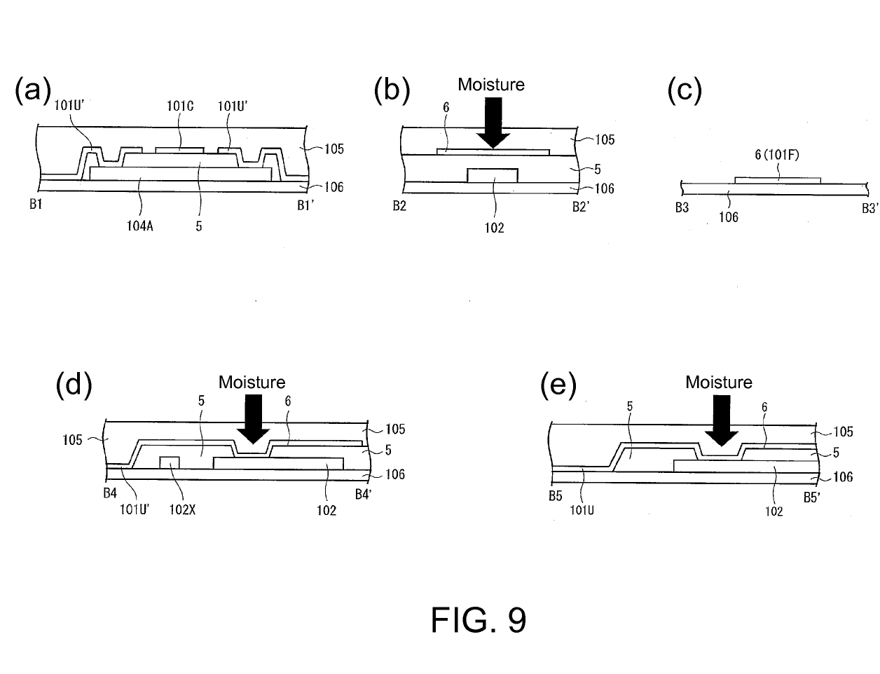

FIG. 9 shows cross-sections of the touch panel 30 shown in FIG. 8. FIG. 9(a) is a cross-sectional view of FIG. 8 along the line B1-B1′, FIG. 9(b) is a cross-sectional view of FIG. 8 along the line B2-B2′, FIG. 9(c) is a cross-sectional view of FIG. 8 along the line B3-B3′, FIG. 9(d) is a cross-sectional view of FIG. 8 along the line B4-B4′, and FIG. 9(e) is a cross-sectional view of FIG. 8 along the line B5-B5′.

FIG. 9(a) shows a portions where a drive electrode line 101D intersects with a sensing electrode line 101S. The first bridge electrode 104A, which is made of a low-resistance metal layer that is the same layer as the metal wiring lines 102 (not shown), is formed as the bottommost layer. In order to prevent the pattern of the first bridge electrode 104A formed of a metal layer from being seen, the interlayer insulating layer 5 made of a black resin, for example, that absorbs visible light is provided on the first bridge electrode 104A.

Adjacent unit electrodes 101U′ in the sensing electrode line 101S are electrically connected to each other through contact holes in the interlayer insulating layer 5 formed on the first bridge electrodes 104A.

On the other hand, adjacent unit electrodes 101U (not shown) in the drive electrode line 101D are electrically connected to each other through a connecting portion 101C formed on the interlayer insulating layer 5.

A protective film 105 that is an organic layer is formed so as to cover the unit electrodes 101U′, the connecting portion 101C, and the interlayer insulating layer 5.

FIG. 9(b) shows a wiring line formation region R2 in the vicinity of the terminal portions 101F. A metal wiring line 102 having a three-layer structure constituted of MoNb/Al/MoNb and in the same layer as the first bridge electrodes 104A is provided. The interlayer insulating film 5 that is an organic layer is provided so as to cover the metal wiring line 102.

A conductive protective layer 6 formed of the same layer as the unit electrodes 101U and 101U′ and the connecting portions 101C is provided on the interlayer insulating film 5 so as to cover the metal wiring line 102 in a plan view.

The protective film 105 that is an organic layer is formed so as to cover the interlayer insulating film 5 and the conductive protective layer 6.

FIG. 9(c) shows a terminal portion 101F formed on one end of the outside of the wiring line formation region R2, and the terminal portions 101F are one end of the conductive protective layers 6 that are made of the same ITO layer as the unit electrodes 101U, the unit electrodes 101U′, and the connecting portions 101C, the terminal portions 101F being exposed so as to be electrically connected to external elements.

FIG. 9(d) shows a portion where the unit electrode 101U′ of the sensing electrode line 101S (not shown) is electrically connected to the metal wiring line 102.

As shown, the conductive protective layer 6 formed in the same layer as the unit electrode 101U′ of the sensing electrode line 101S (not shown) and electrically connected thereto is electrically connected to the metal wiring line 102 through a contact hole of the interlayer insulating film 5 formed over the metal wiring line 102, and in the layer above the metal wiring lines 102 and the ground wiring lines 102X, the conductive protective layers 6 are provided, and thus, the conductive protective layers 6 protect the metal wiring lines 102 and the ground wiring line 102X.

The protective film 105 is formed so as to cover the interlayer insulating film 5 and the conductive protective layers 6.

FIG. 9(e) shows a portion where the unit electrode 101U of the drive electrode line 101D (not shown) is electrically connected to the metal wiring line 102.

As shown, the conductive protective layer 6 formed in the same layer as the unit electrode 101U of the drive electrode line 101D (not shown) and electrically connected thereto is electrically connected to the metal wiring line 102 through a contact hole of the interlayer insulating film 5 formed over the metal wiring line 102, and in the layer above the metal wiring lines 102, the conductive protective layers 6 are provided, and thus, the conductive protective layers 6 protect the metal wiring lines 102.

The protective film 105 is formed so as to cover the interlayer insulating film 5 and the conductive protective layers 6.

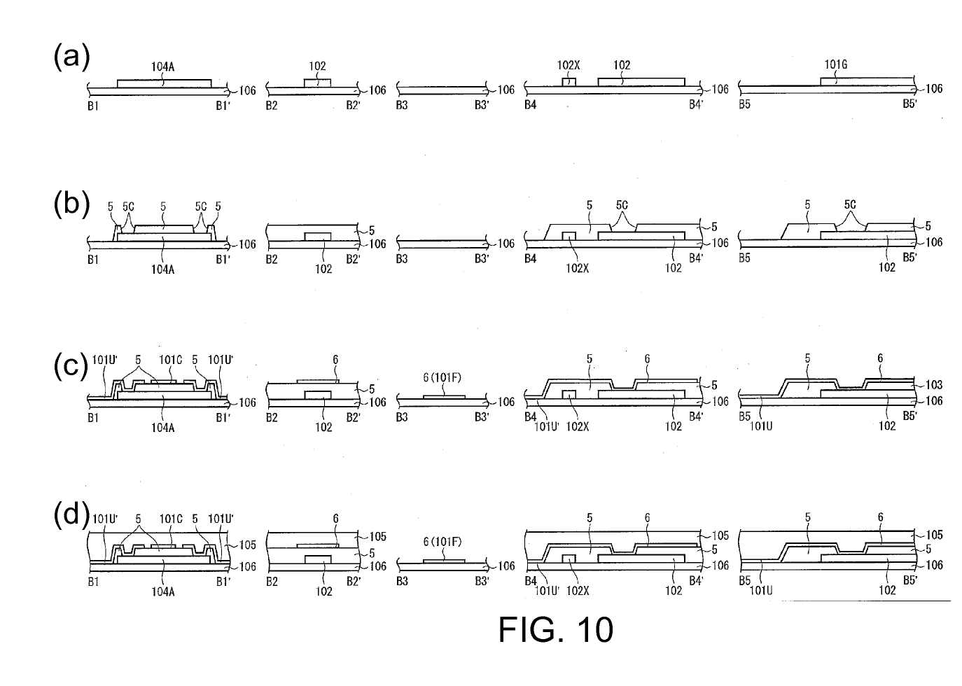

FIGS. 10(a) to 10(d) show manufacturing steps for the touch panel 30 described above. FIG. 10(a) shows steps of forming the first bridge electrodes 104A, and the metal wiring lines 102 and ground wiring line 102X formed of the same layer as the first bridge electrodes 104A, FIG. 10(b) shows a step of forming the interlayer insulating film 5, FIG. 10(c) shows a step of forming the conductive protective layer 6, and the unit electrodes 101U and 101U′ and connecting portions 101C made of an ITO layer that is the same layer as the conductive protective layer 6, and FIG. 10(d) shows a step of forming a protective film 105.

As shown, the manufacturing steps for the touch panel 30 can be performed with four mask steps, and thus, it is possible to reduce the number of manufacturing steps compared to the conventional touch panel 100 shown in FIG. 36 despite the inclusion of the conductive protective layer 6.

In the touch panel 30 of the present embodiment, it is possible to reduce the appearance of patterns of the first bridge electrodes 104A in the touch detection region R1 due to the use of black resin for the interlayer insulating layer 5, and thus, it is possible to have an improved display quality when combined with a display device.

In the present embodiment, the interlayer insulating layer 5 made of black resin is provided on the first bridge electrodes 104A in order to prevent the appearance of patterns of the first bridge electrodes 104A made of a metal layer, but the configuration is not limited thereto; if the touch panel 30 is not an integral cover glass, it is also possible prevent the appearance of patterns of the first bridge electrodes 104A by providing a black matrix layer (low-reflection metal layer) made of a metal to be described in more detail in Embodiment 5 on the first bridge electrodes 104A made of a low-resistance metal layer that is the same metal layer as that of the metal wiring lines 102. In such a case, the interlayer insulating film can be made of a transparent insulating material, and can be of an island type or contact hole type.

### Embodiment 5

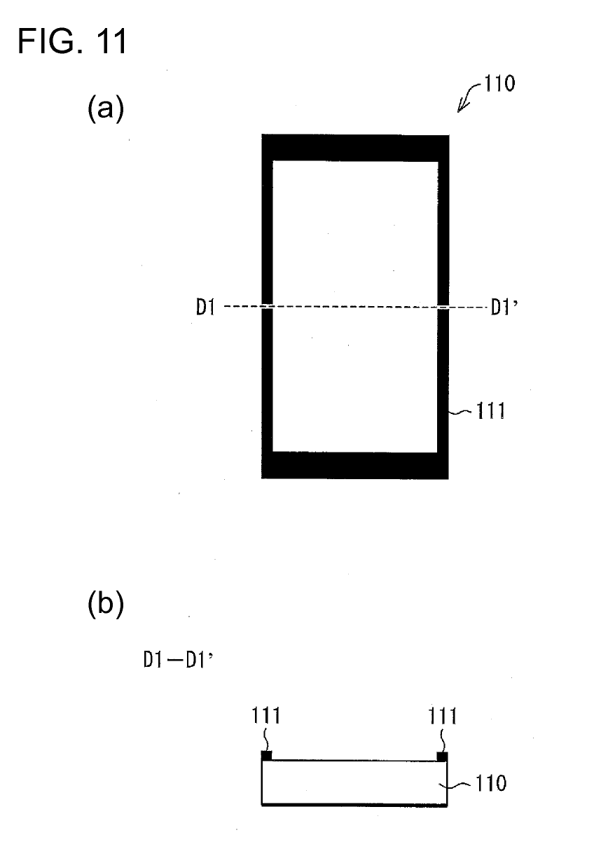

Embodiment 5 of the present invention will be described with reference to FIGS. 11 to 17. The touch panel 40 of the present embodiment differs from Embodiment 4 in that, in order to reduce the appearance of patterns of first bridge electrodes 104A made of metal in the touch detection region R1, a black matrix layer 7 (low-reflection metal layer) made of metal is formed below the first bridge electrodes 104A, but other aspects are as described in Embodiment 4. For ease of description, members that have the same functions as members shown in drawings of Embodiment 4 will be assigned the same reference characters, and descriptions thereof will be omitted.

FIG. 11 shows a cover glass included in a conventional touch panel.

FIG. 11(a) is a plan view showing a cover glass (tempered glass) 110 having a black matrix (BM) 111 formed in the frame region, and FIG. 11(b) is a cross-sectional view of FIG. 11(a) along the line D1-D1′.

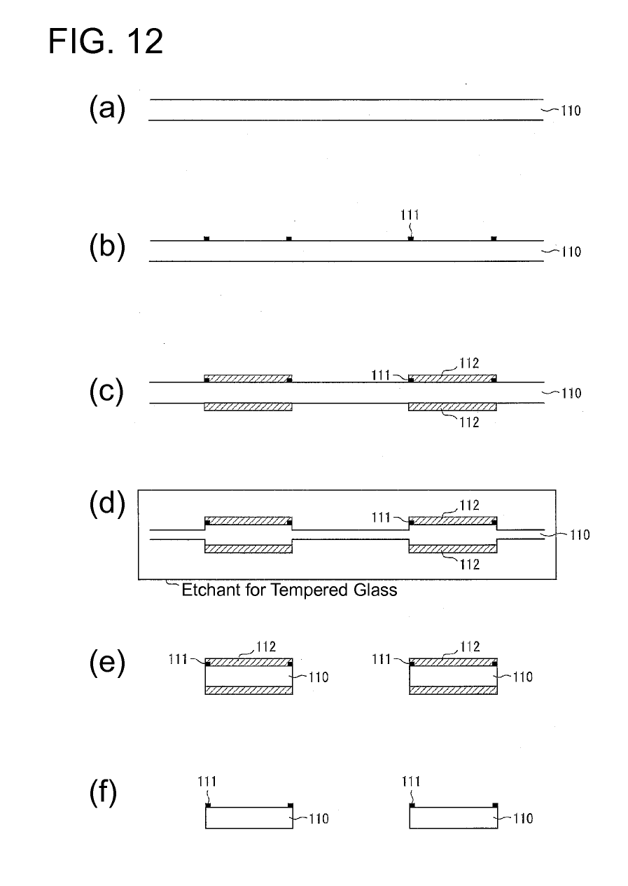

FIG. 12 is for describing conventional manufacturing steps for the cover glass (tempered glass) 110 on which the black matrix (BM) 111 is formed in the frame region as shown in FIG. 11.

On the cover glass 110 shown in FIG. 12(a), a black matrix 111 of a prescribed shape such as that shown in FIG. 12(b) is formed by exposure and developing steps.

As shown in FIG. 12(c), a resist 112 having a prescribed shape is formed by exposure and developing steps in order to protect the black matrix 111 of a prescribed shape and the cover glass 110 from the cover glass (tempered glass) etchant.

Also, as shown in FIG. 12(d), the black matrix 111, cover glass 110, and resist 112 are treated in the cover glass (tempered glass) etchant, and as shown in FIG. 12(e), these can be split into a plurality of cover glasses (tempered glass) 110.

Finally, as shown in FIG. 12(f), by removing the resist 112, it is possible to form a plurality of cover glasses 110 on which the black matrices 111 are formed in the frame portions.

However, the method to form such a cover glass 110 on which the black matrix 111 is formed in the frame portion required a large number of manufacturing steps, and thus, caused an increase in manufacturing unit cost for the touch panel.

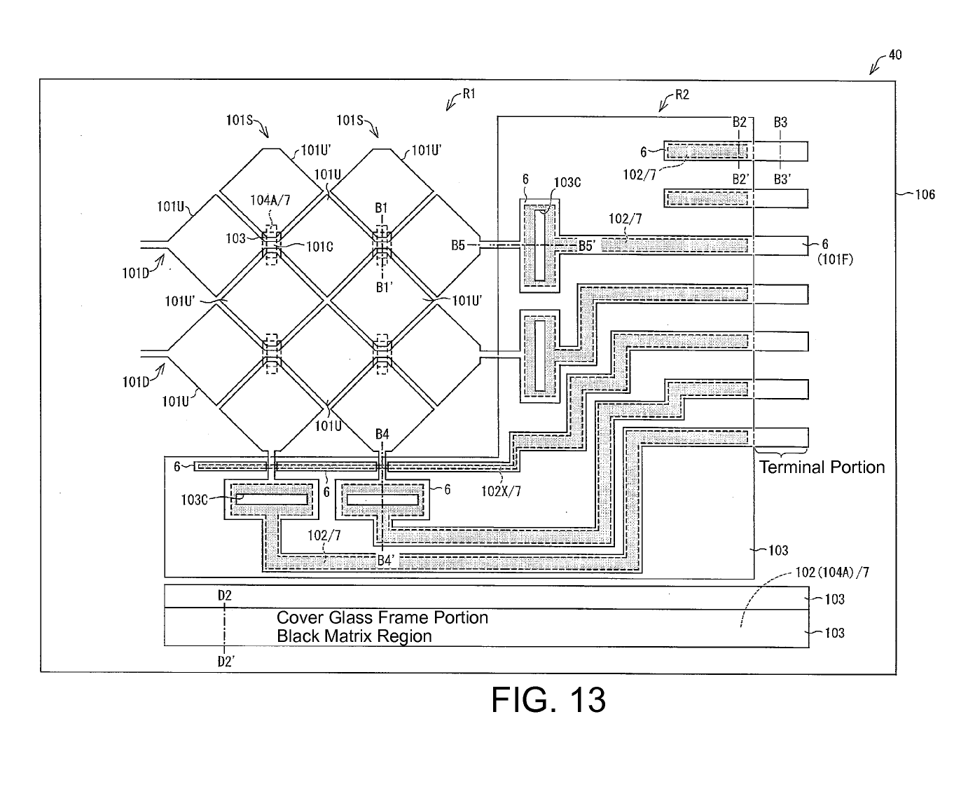

FIG. 13 shows a schematic configuration of the touch panel 40.

As shown, in the touch panel 40, the surface of the substrate 106 to the rear of the surface where the respective layers are formed is the touch surface, and thus, in the touch detection region R1, the black matrix layer 7 (low-reflection metal layer) made of metal is formed below the first bridge electrodes 104A in order to make the pattern of the first bridge electrodes 104A formed of a metal layer less visible.

In the present embodiment, the first bridge electrodes 104A and the metal wiring lines 102 made of metal and the black matrix layer 7 made of metal are patterned using one mask, and thus, in the wiring line formation region R2, the black matrix layer 7 made of metal is also formed below the metal wiring lines 102.

Also, as shown towards the bottom of FIG. 13, if the black matrix is formed in the frame portion, it is possible to form the layer in the black matrix region by which the black matrix layer 7 and the first bridge electrodes 104A and metal wiring lines 102, which are in the same layer, are formed, and thus, there is no need to add a step to form the black matrix in the frame region on a cover glass such as that shown in FIG. 12.

In other words, in the present embodiment, it is possible to form a black matrix in the frame region in the same step as forming the black matrix layer 7 made of metal below the first bridge electrodes 104A in order to reduce the appearance of the pattern of the first bridge electrodes 104A made of metal in the touch detection region R1.

Therefore, it is possible to attain a touch panel 40 with improved reliability without increasing the manufacturing unit cost.

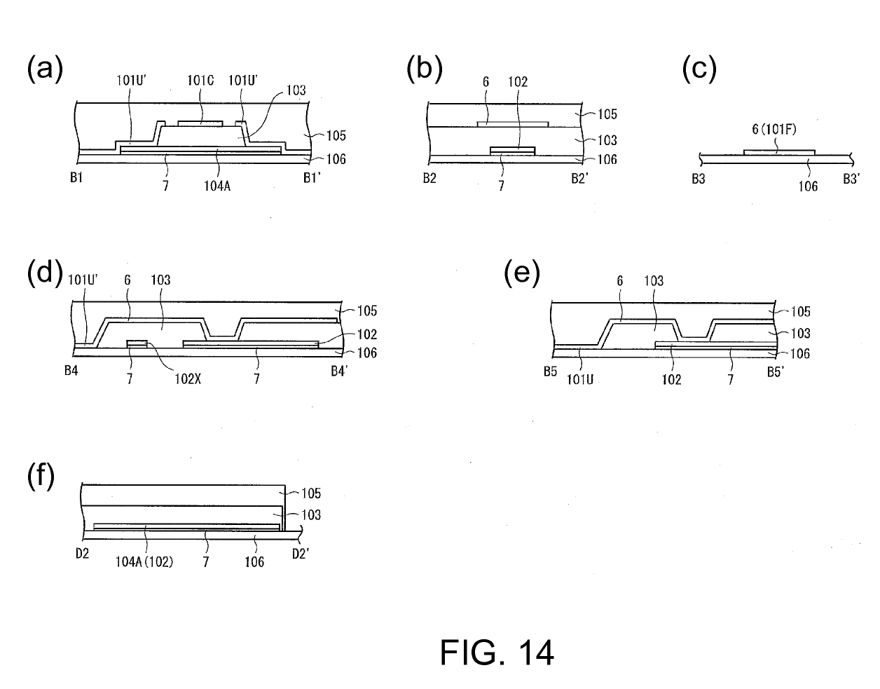

FIG. 14 shows cross-sectional views of the touch panel 40 shown in FIG. 13. FIG. 14(a) is a cross-sectional view of FIG. 13 along the line B1-B1′, FIG. 14(b) is a cross-sectional view of FIG. 13 along the line B2-B2′, FIG. 14(c) is a cross-sectional view of FIG. 13 along the line B3-B3′, FIG. 14(d) is a cross-sectional view of FIG. 13 along the line B4-B4′, FIG. 14(e) is a cross-sectional view of FIG. 13 along the line B5-B5′, and FIG. 14(f) is a cross-sectional view of FIG. 13 along the line D2-D2′.

FIG. 14(a) shows a portion where a drive electrode line 101D intersects with a sensing electrode line 101S, and in order to prevent the appearance of the pattern of the first bridge electrodes 104A made of metal, the black matrix layer 7 (low-reflection metal layer) made of metal is formed below the first bridge electrode 104A made of a low resistance metal layer that is the same layer as that of the metal wiring lines 102 (not shown).

As shown, the black matrix layer 7 made of metal is formed as the bottommost layer.

Adjacent unit electrodes 101U′ in the sensing electrode line 101S are electrically connected to both ends of the first bridge electrode 104A.

On the other hand, adjacent unit electrodes 101U (not shown) in the drive electrode line 101D are electrically connected to each other through a connecting portion 101C formed on the interlayer insulating layer 103.

A protective film 105 that is an organic layer is formed so as to cover the unit electrodes 101U′, the connecting portion 101C, and the interlayer insulating layer 5.

FIG. 14(b) shows the wiring line formation region R2 in the vicinity of the terminal portions 101F, and the black matrix layer 7 made of metal is provided below the metal wiring line 102 having a three-layer structure constituted of MoNb/Al/MoNb, which is in the same layer as the first bridge electrode 104A, and the interlayer insulating film 103 that is an organic layer is provided so as to cover the metal wiring lines 102.

A conductive protective layer 6 formed of the same layer as the unit electrodes 101U and 101U′ and the connecting portions 101C is provided on the interlayer insulating film 103 so as to cover the metal wiring line 102 in a plan view.

Then the organic protective film 105 is formed so as to cover the conductive protective layer 6 and the interlayer insulating film 103.

FIG. 14(c) shows a terminal portion 101F formed on one end on the outside of the wiring line formation region R2; one end of the conductive protective layer 6, which is formed of an ITO layer that is the same layer as the unit electrode 101U, the unit electrode 101U′, and the connecting portion 101C, is the terminal portion 101F, which is exposed in order to be electrically connected to external elements.

FIG. 14(d) shows a portion where the unit electrode 101U′ of the sensing electrode line 101S (not shown) is electrically connected to the metal wiring line 102.

As shown, the black matrix layer 7 made of metal is provided below the ground wiring line 102X and the metal wiring line 102, and the conductive protective layer 6 formed in the same layer as the unit electrode 101U′ of the sensing electrode line 101S (not shown) that is electrically connected thereto is electrically connected to the metal wiring lines 102 through contact holes in the interlayer insulating film 103 formed on the metal wiring line 102, and the conductive protective layer 6 is formed over the metal wiring line 102 and the ground wiring line 102X, and thus, the metal wiring line 102 and the ground wiring line 102X are protected by the conductive protective layer 6.

The protective film 105 is formed so as to cover the interlayer insulating film 5 and the conductive protective layers 6.

FIG. 14(e) shows a portion where the unit electrode 101U of the drive electrode line 101D (not shown) is electrically connected to the metal wiring line 102.

As shown, a black matrix layer 7 made of metal is provided below the metal wiring line 102, and the conductive protective layer 6 that is formed in the same layer as the unit electrode 101U of the drive electrode line 101D (not shown) and electrically connected thereto is electrically connected to the metal wiring line 102 through contact holes in the interlayer insulating film 103 formed on the metal wiring line 102. The conductive protective layer 6 is provided over the metal wiring line 102, and thus, the metal wiring line 102 is protected by the conductive protective layer 6.

The protective film 105 is formed so as to cover the interlayer insulating film 103 and the conductive protective layers 6.

FIG. 14(f) shows a black matrix region formed in the frame portion.

As shown, the black matrix layer 7 made of metal, the first bridge electrode 104A and metal wiring lines 102 in the same layer, the interlayer insulating film 103, and the protective film 105 are layered in this order.

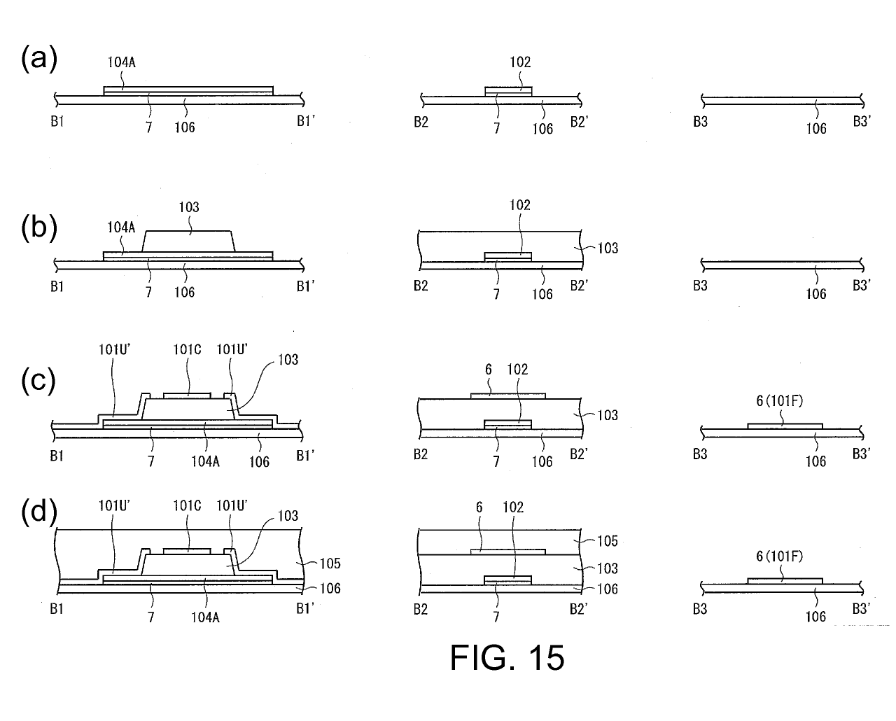

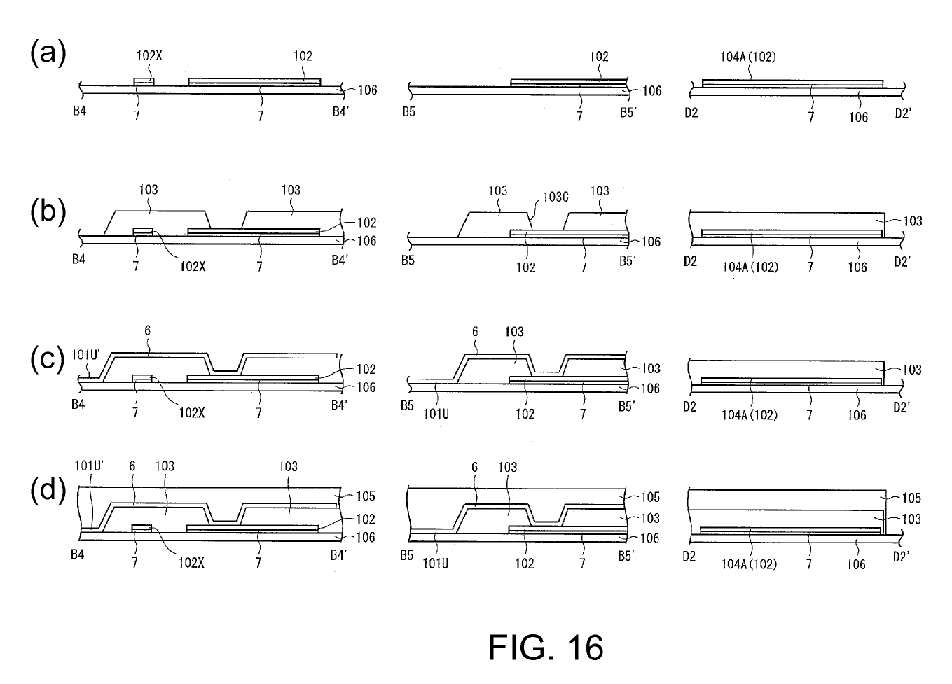

FIGS. 15(a) to 15(d) and 16(a) to 16(d) show manufacturing steps for the touch panel 40 mentioned above. FIGS. 15(a) and 16(a) show a step of forming the black matrix layer 7 made of metal, and the first bridge electrode 104A, metal wiring lines 102, and ground wiring line 102X, which are formed in the same layer, by one mask step, FIGS. 15(b) and 16(b) show a step of forming the interlayer insulating film 103, FIGS. 15(c) and 16(c) show a step of forming the conductive protective layer 6, and the unit electrodes 101U and 101U′ and connecting portion 101C formed of an ITO layer that is the same layer as the conductive protective layer 6, and FIGS. 15(d) and 16(d) show a step of forming the protective film 105.

The touch panel 40 described above is provided with the black matrix layer 7 (low-reflection metal layer) made of metal and formed below the first bridge electrodes 104A, the conductive protective layer 6, and the black matrix region in the frame portion in order to reduce the appearance of the pattern of the first bridge electrodes 104A made of metal. Despite this, the manufacturing of the touch panel 40 can be performed with four mask steps, and thus, the number of manufacturing steps can be reduced compared to that of the conventional touch panel 100 shown in FIG. 36.

In the touch panel 40, the black matrix layer 7 (low-reflection metal layer) made of metal is provided below the first bridge electrodes 104A, and thus, the appearance of the pattern of the first bridge electrodes 104A made of metal can be reduced, and the display quality can be improved when the touch panel 40 is combined with a display device.

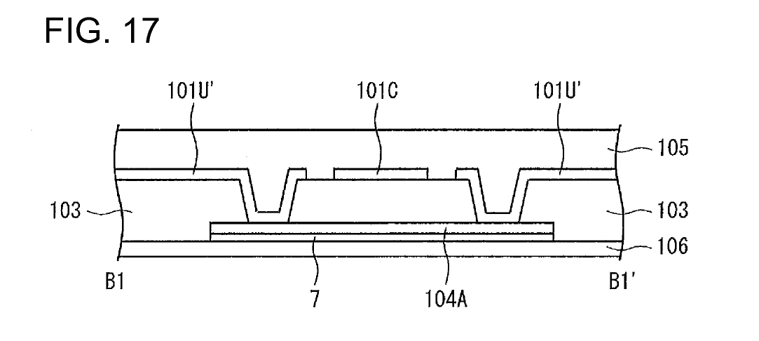

In the present embodiment, as shown in FIG. 14(a), a method is used in which the adjacent unit electrodes 101U′ of the sensing electrode line 101S are directly connected to both ends on the first bridge electrode 104A, but the configuration is not limited thereto, and as shown in FIG. 17, the connection between the first bridge electrode 104A and the adjacent unit electrodes 101U′ of the sensing electrode line 101S may be accomplished by contact holes formed in the interlayer insulating film 103.

### Embodiment 6

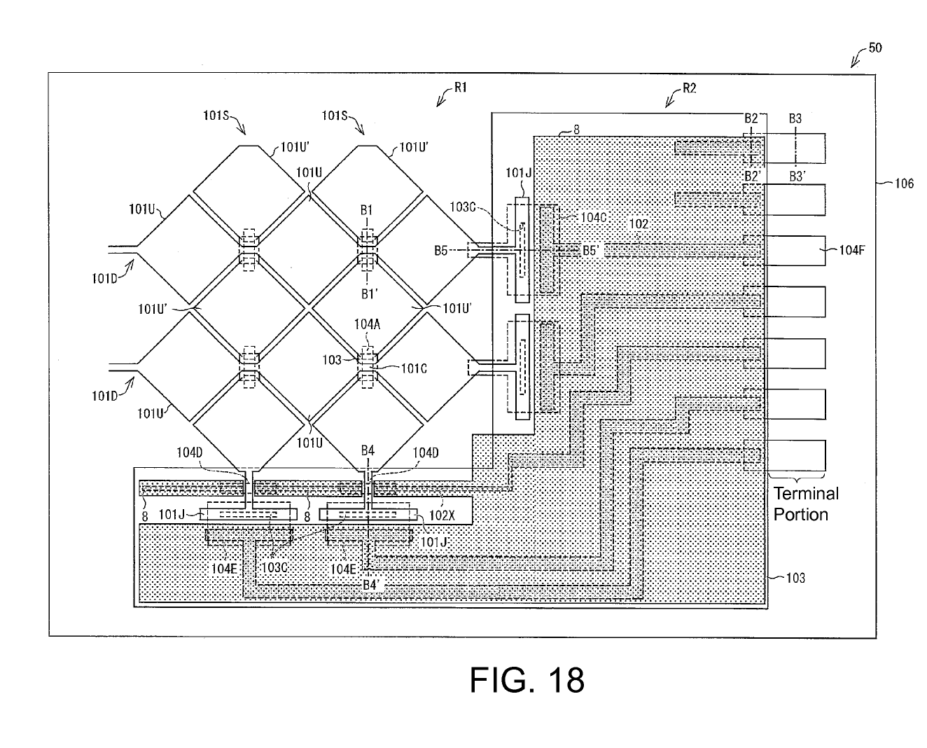

Embodiment 6 of the present invention will be described with reference to FIGS. 18 to 20. The touch panel 50 of the present invention differs from Embodiments 1 to 5 in that first bridge electrodes 104A made of a transparent conductive layer are the bottommost layer, and other aspects are as described in Embodiments 1 to 5. For ease of description, members that have the same functions as members shown in drawings of Embodiments 1 to 5 will be assigned the same reference characters, and descriptions thereof will be omitted.

FIG. 18 shows a schematic configuration of the touch panel 50.

As shown, in the touch panel 50, the first bridge electrodes 104A made of a transparent conductive layer such as ITO, connecting electrodes 104D for connecting relay electrodes 104C and 104E formed of the same layer as the first bridge electrodes 104A to the ground wiring line 102X, and terminal portions 104F are formed in the bottommost layer.

Unit electrodes 101U of drive electrode lines 101D, unit electrodes 101U′ of sensing electrode lines 101S, connecting portions 101C, a conductive protective layer 8, and connecting electrodes 101J connected to the unit electrodes 101U of the drive electrode lines 101D and the unit electrodes 101U′ of the sensing electrode lines 101S, which are all made of the same transparent conductive layer such as ITO, are provided on the interlayer insulating film 103.

In the touch panel 50 of the present embodiment, the first bridge electrodes 104A are made of a transparent conductive layer such as ITO, and thus, the appearance of a pattern of the first bridge electrodes 104A is not an issue. Therefore, there is no need to provide an interlayer insulating layer 5 made of black resin or a black matrix layer 7 (low-reflection metal layer), which are made of a material used in Embodiments 4 and 5 that absorbs visible light, for example, in the touch detection region R1.

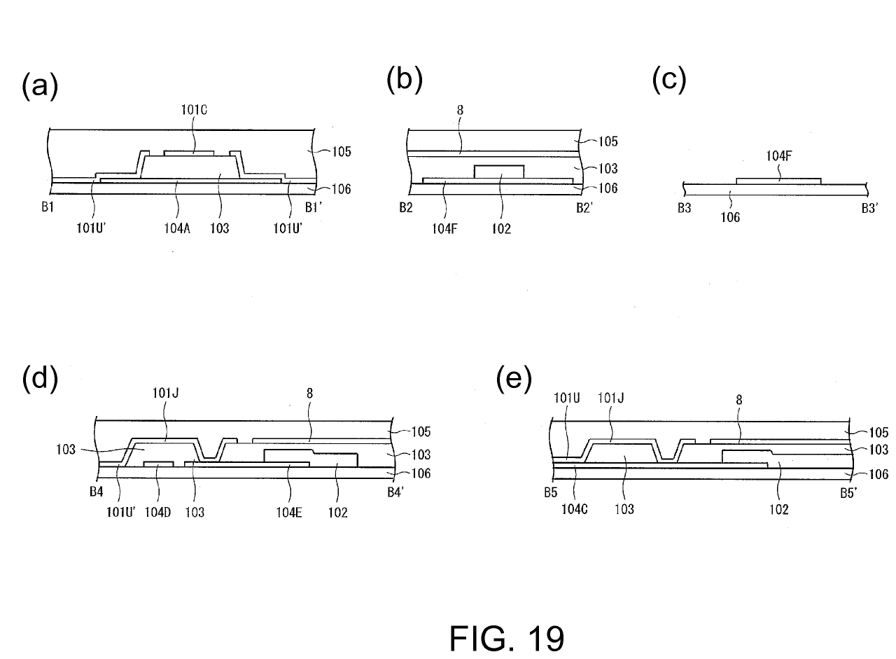

FIG. 19 shows cross-sections of the touch panel 50 shown in FIG. 18. FIG. 19(a) is a cross-sectional view of FIG. 18 along the line B1-B1′, FIG. 19(b) is a cross-sectional view of FIG. 18 along the line B2-B2′, FIG. 19(c) is a cross-sectional view of FIG. 18 along the line B3-B3′, FIG. 19(d) is a cross-sectional view of FIG. 18 along the line B4-B4′, and FIG. 19(e) is a cross-sectional view of FIG. 18 along the line B5-B5′.

FIG. 19(a) shows a portion where a drive electrode line 101D intersects with a sensing electrode line 101S, and the first bridge electrode 104A made of a transparent conductive layer such as ITO is formed as the bottommost layer.

Adjacent unit electrodes 101U′ in the sensing electrode line 101S are electrically connected to both ends of the first bridge electrode 104A.

On the other hand, adjacent unit electrodes 101U (not shown) in the drive electrode line 101D are electrically connected to each other through a connecting portion 101C formed on the interlayer insulating layer 103.

A protective film 105 that is an organic layer is formed so as to cover the unit electrodes 101U′, the connecting portion 101C, and the interlayer insulating layer 5.

Adjacent unit electrodes 101U′ of the sensing electrode line 101S may be connected through contact holes formed in the interlayer insulating layer 103 and the first bridge electrode 104A.

FIG. 19(b) shows a wiring line formation region R2 in the vicinity of the terminal portions 104F, and a metal wiring line 102 having a three-layer structure constituted of MoNb/Al/MoNb is formed on a terminal portion 104F formed of the same layer as that of the first bridge electrodes 104A.

The interlayer insulating film 103 that is an organic layer is provided so as to cover the terminal portions 104F and the metal wiring lines 102.

A conductive protective layer 8 formed of the same layer as the unit electrodes 101U and 101U′ and the conductive portions 101C is formed on the interlayer insulating film 103 so as to cover all of the plurality metal wiring lines 102.

The protective film 105 that is an organic layer is formed so as to cover the conductive protective layer 8.

FIG. 19(c) shows a terminal portion 104F formed on one end outside of the wiring line formation region R2, and the terminal portion 104F is formed as the bottommost layer, which is the same layer as the first bridge electrode 104A, the relay electrodes 104C and 104E, and connecting electrodes 104D for connecting the ground wiring line 102X, and the terminal portion 104F is exposed in order to be electrically connected to external elements.

FIG. 19(d) shows a portion where the unit electrode 101U′ of the sensing electrode line 101S (not shown) is electrically connected to the metal wiring line 102.

As shown, the connecting electrode 104D and the relay electrode 104E, which are formed in the same layer as the first bridge electrode 104A, for connecting the ground wiring line 102X are formed in the bottommost layer, and the metal wiring line 102 is formed so as to be in contact with the relay electrode 104E.

The connecting electrode 101J connected to the unit electrode 101U′ is connected to the metal wiring line 102 through the contact hole formed in the interlayer insulating film 103 and the relay electrode 104E.

The conductive protective layer 8 is provided over the metal wiring line 102 across the interlayer insulating film 103, and thus, the metal wiring line 102 is protected by the conductive protective layer 8.

The protective film 105 is formed so as to cover the interlayer insulating film 103 and the conductive protective layer 8.

FIG. 19(e) shows a portion where the unit electrode 101U of the drive electrode line 101D (not shown) is electrically connected to the metal wiring line 102.

As shown, the relay electrode 104C formed of the same layer as the first bridge electrode 104A is the bottommost layer, and the metal wiring line 102 is formed so as to be in contact with the relay electrode 104C.

The connecting electrode 101J connected to the unit electrode 101U is connected to the metal wiring line 102 through the contact hole formed in the interlayer insulating film 103 and the relay electrode 104C.

The conductive protective layer 8 is provided over the metal wiring line 102 across the interlayer insulating film 103, and thus, the metal wiring line 102 is protected by the conductive protective layer 8.

The protective film 105 is formed so as to cover the interlayer insulating film 103, the conductive protective layer 8, and the connecting electrode 101J connected to the unit electrode 101U.

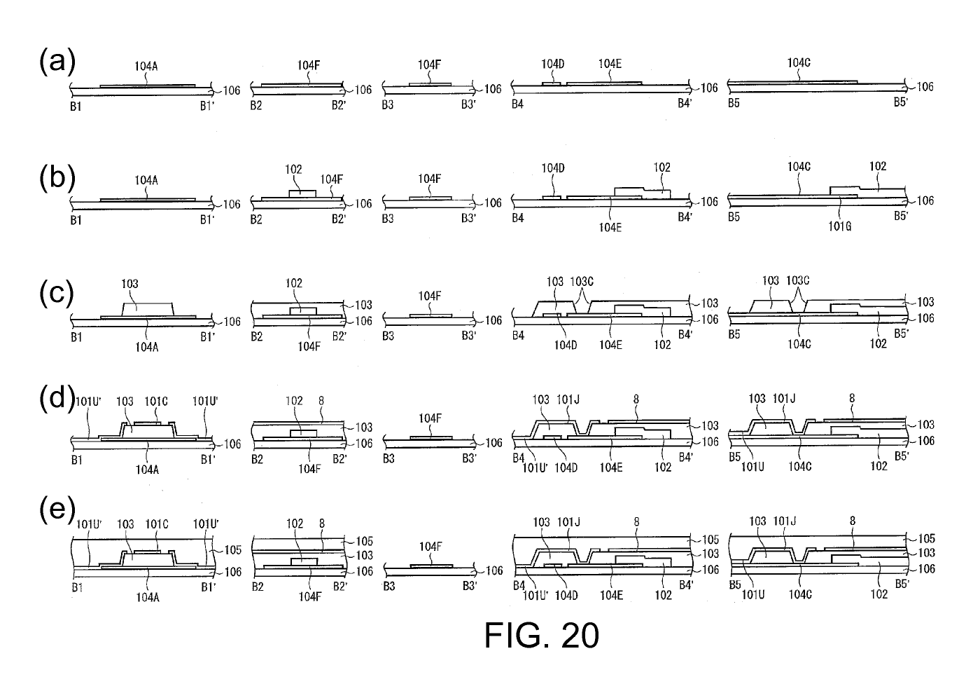

FIGS. 20(a) to 20(e) show manufacturing steps for the touch panel 50 mentioned above. FIG. 20(a) shows a step of forming the first bridge electrodes 104A made of a transparent conductive film such as ITO, connecting electrodes 104D, which are formed of the same layer as the first bridge electrodes 104A, for connecting the relay electrodes 104C and 104E and ground wiring line 102X, and the terminal portions 104F.

FIG. 20(b) shows a step of forming the metal wiring lines 102, FIG. 20(c) shows a step of forming the interlayer insulating film 103, FIG. 20(d) shows a step of forming the conductive protective layer 8, the unit electrodes 101U and 101U′, the connecting portions 101C, and the connecting electrodes 101J connected to the unit electrodes 101U or the unit electrodes 101U′, which are all formed of the same ITO layer, and FIG. 20(e) shows a step of forming the protective film 105.

As shown, the manufacturing steps for the touch panel 50 can be performed with five mask steps, and thus, it is possible to reduce the number of manufacturing steps compared to the conventional touch panel 100 shown in FIG. 36 despite the inclusion of the conductive protective layer 8.

In the touch panel 50 of the present embodiment, the first bridge electrodes 104A are made of a transparent conductive layer such as ITO, and thus, the appearance of the pattern of the first bridge electrodes 104A is not an issue. Therefore, when combining the touch panel 50 with a display device, it is possible to improve the display quality.

### Embodiment 7

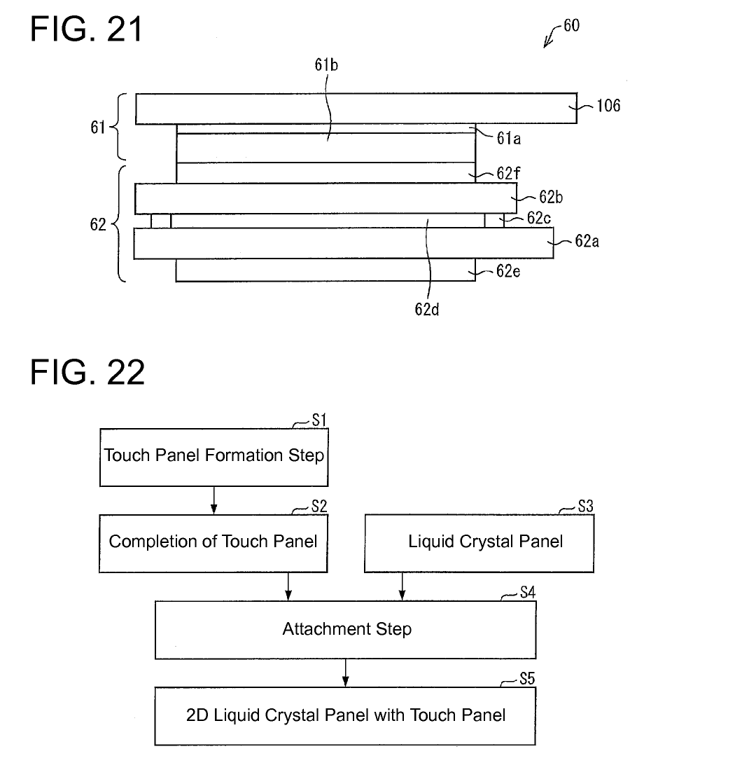

Embodiment 7 of the present invention will be described with reference to FIGS. 21 to 33. In the present embodiment, manufacturing steps for a liquid crystal display device (display device) including the touch panel disclosed in Embodiments 1 to 6 will be described.

FIG. 21 shows an example of a 2D liquid crystal display device 60 including a touch panel.

As shown, a touch panel 61 includes a substrate 106, a substrate 61b provided opposite to the substrate 106, a plurality of films 61a formed between the substrates 106 and 61b, on one of them.

On the other hand, a liquid crystal panel 62 includes a TFT substrate 62a, a color filter substrate 62b, a sealing material 62c for bonding the substrates together, a liquid crystal layer 62d sealed between the bonded substrates, a polarizing plate 62e provided on a surface of the TFT substrate 62a opposite to the surface in contact with the liquid crystal layer 62d, and a polarizing plate 62f provided on a surface of the color filter substrate 62b opposite to the surface in contact with the liquid crystal layer 62d.

FIG. 22 shows one example of manufacturing steps for the 2D liquid crystal display device 60 including the touch panel shown in FIG. 21.

As disclosed in the respective embodiments, the plurality of films 61a are formed on the substrate 106 (S1). Then the substrate 61b is provided, thus completing the touch panel 61 (S2).

Meanwhile, the liquid crystal panel 62 is completed by a conventional manufacturing method for a liquid crystal panel (S3).

Then, using an adhesive layer (not shown) or the like, the touch panel 61 and the liquid crystal panel 62 can be bonded together (S4), and the 2D liquid crystal display device 60 having a touch panel can be completed (S5).

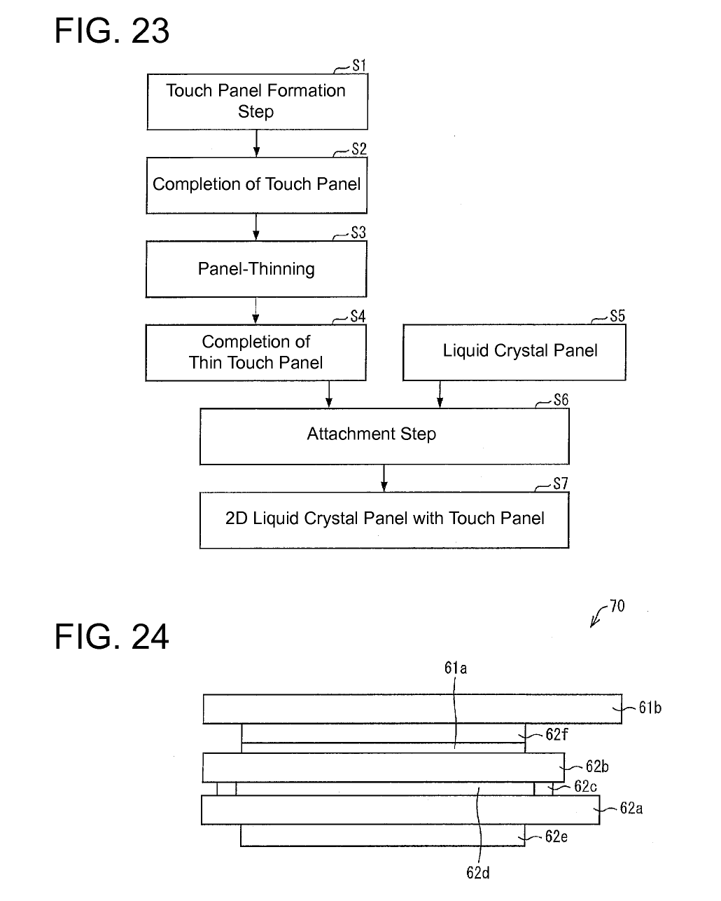

FIG. 23 shows one example of manufacturing steps for the 2D liquid crystal display device 60 including the touch panel shown in FIG. 21 but with a thinned configuration.

The manufacturing steps shown in FIG. 23 differ from the manufacturing steps shown in FIG. 22 in that a step of panel-thinning (S3) is included in which the substrate 106 and substrate 61b included in the touch panel 61 is thinned.

The step of panel-thinning is a step in which the substrate 106 and the substrate 61b are treated with an etchant.

FIG. 24 shows an example of a liquid crystal display device 70 including an on-cell type touch panel.

As shown, in the liquid crystal display device 70, a plurality of films 61a are formed on the surface of the color filter substrate 62b opposite to the surface thereof in contact with the liquid crystal layer 62d, the polarizing plate 62f is formed on the plurality of films 61a, and lastly, the substrate 61b is formed on the polarizing plate 62f, which is a difference from the 2D liquid crystal display device 60 including the touch panel shown in FIG. 21.

The liquid crystal display device 70 can be thinned by having one fewer substrate included on the touch panel side.

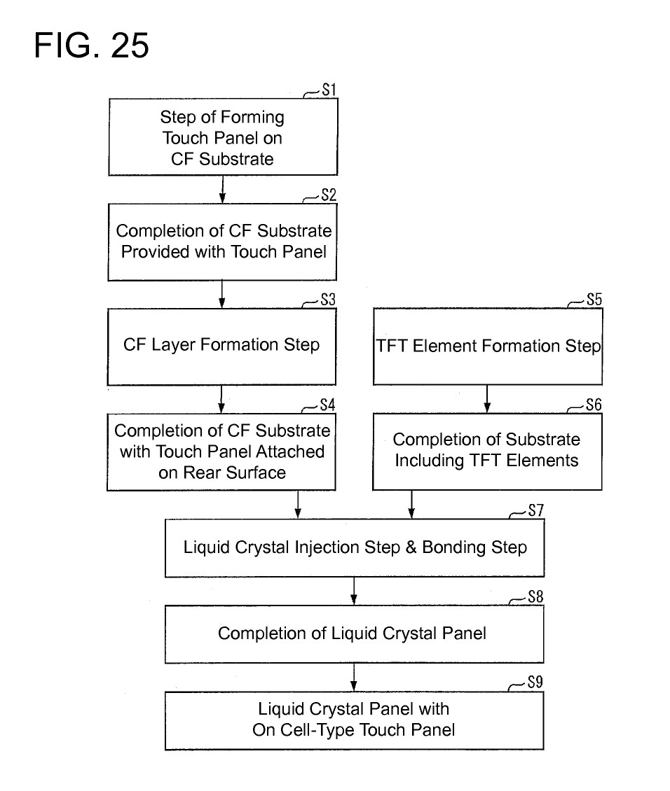

FIG. 25 shows one example of manufacturing steps for the liquid crystal display device 70 including the on-cell type touch panel shown in FIG. 24.

First, on a color filter substrate 62b, the plurality of films 61a is formed on the surface thereof opposite to that in contact with the liquid crystal layer 62d (S1), and the color filter substrate 62b including the touch panel is completed (S2).

On the color filter substrate 62b, a color filter layer is formed on the surface facing the liquid crystal layer 62d (S3), and the color filter substrate 62b having the touch panel on the rear surface thereof and the color filter layer is completed (S4).

Meanwhile, on the TFT substrate 62a, TFT elements are formed on the surface in contact with the liquid crystal layer 62d (S5), and the TFT substrate 62a including TFT elements is completed (S6).

The substrates are bonded together and liquid crystal is injected (S7), and then, the polarizing plates 62e and 62f are attached, thus completing the liquid crystal panel (S8). In the step of liquid crystal injection and the step of bonding (S7), the ODF method may be used in which liquid crystal is dripped thereon and then the substrates are bonded.

Lastly, the substrate 61b is provided, thus completing the liquid crystal display device 70 with an on-cell touch panel attached (S9).

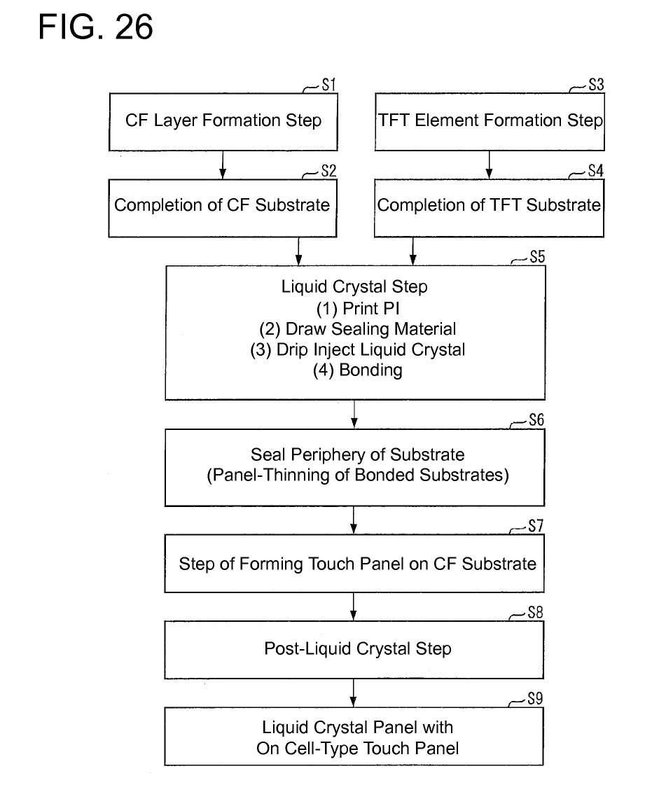

FIG. 26 shows one example of manufacturing steps for the liquid crystal display device 70 including an on-cell touch panel shown in FIG. 24, but with a thinned configuration.

First, on the color filter substrate 62b, the color filter layer is formed on the surface thereof in contact with the liquid crystal layer 62d (S1), and the color filter substrate 62b including the color filter layer is completed (S2).

Meanwhile, on the TFT substrate 62a, TFT elements are formed on the surface in contact with the liquid crystal layer 62d (S3), and the TFT substrate 62a including TFT elements is completed (S4).

A pre-liquid crystal step (S5) including the steps of printing alignment films (PI) on the respective substrates, and bonding the substrates together after the sealing material is drawn and liquid crystal drip injected on one of the substrates is performed.

Then a panel thinning step is performed on both substrates (S6) in which the periphery of the bonded substrates is sealed.

Then, on the color filter substrate 62b, a plurality of films 61a are formed on a surface thereof opposite to that provided with the color filter layer (S7), and a post-liquid crystal step in which the polarizing plates 62e and 62f are attached is performed (S8).

Lastly, the substrate 61b is provided, thus completing the liquid crystal display device 70 with an on-cell touch panel attached (S9).

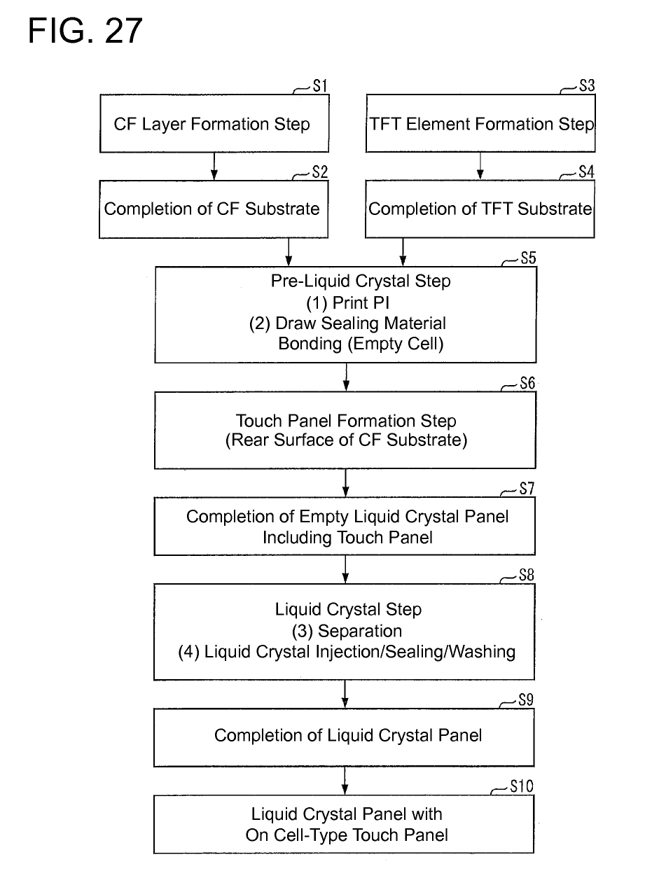

FIG. 27 shows another example of manufacturing steps for the liquid crystal display device 70 including an on-cell touch panel shown in FIG. 24.

First, on the color filter substrate 62b, the color filter layer is formed on the surface thereof in contact with the liquid crystal layer 62d (S1), and the color filter substrate 62b including the color filter layer is completed (S2).

Meanwhile, on the TFT substrate 62a, TFT elements are formed on the surface thereof in contact with the liquid crystal layer 62d (S3), and the TFT substrate 62a including the TFT elements is completed (S4).

Then, a pre-liquid crystal step is performed in which alignment films (PI) are printed on the respective substrates, the sealing material is drawn on either of the substrates, and the substrates are bonded together, thus forming an empty cell (S5).

Then, on the color filter substrate 62b, the plurality of films 61a are formed on the surface thereof opposite to that provided with the color filter layer (S6), and the empty liquid crystal panel with a touch panel is completed (S7).

Then a liquid crystal step is performed in which the empty liquid crystal panel is separated, and liquid crystal injection, sealing, and washing are performed (S8).

Then the polarizing plates 62e and 62f are attached and the liquid crystal panel is completed (S9).

Lastly, the substrate 61b is provided, thus completing the liquid crystal display device 70 with an on-cell touch panel attached (S10).

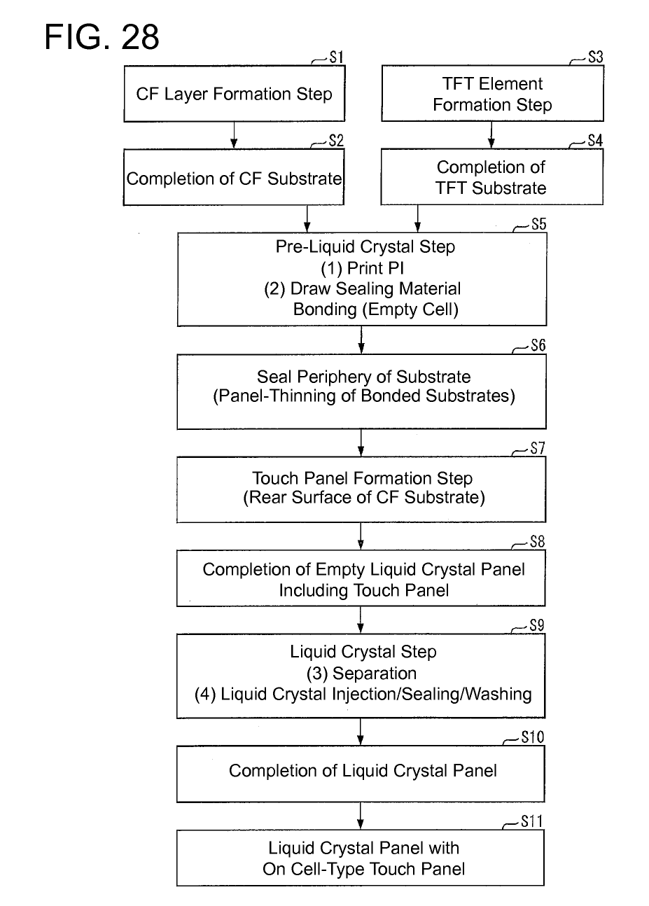

FIG. 28 shows another example of manufacturing steps for the liquid crystal display device 70 including the on-cell touch panel shown in FIG. 24, but with a thinned configuration.

First, on the color filter substrate 62b, the color filter layer is formed on the surface thereof in contact with the liquid crystal layer 62d (S1), and the color filter substrate 62b including the color filter layer is completed (S2).

Meanwhile, on the TFT substrate 62a, TFT elements are formed on the surface thereof in contact with the liquid crystal layer 62d (S3), and the TFT substrate 62a including the TFT elements is completed (S4).

Then, a pre-liquid crystal step is performed in which alignment films (PI) are printed on the respective substrates, the sealing material is drawn on either of the substrates, and the substrates are bonded together, thus forming an empty cell (S5).

Then a panel thinning step is performed on both substrates (S6) in which the periphery of the empty cell is sealed.

Then, on the color filter substrate 62b, the plurality of films 61a are formed on the surface thereof opposite to that provided with the color filter layer (S7), and the empty liquid crystal panel with a touch panel is completed (S8).

Then a liquid crystal step is performed in which the empty liquid crystal panel is separated, and liquid crystal injection, sealing, and washing are performed (S9).

Then the polarizing plates 62e and 62f are attached and the liquid crystal panel is completed (S10).

Lastly, the substrate 61b is provided, thus completing the liquid crystal display device 70 with an on-cell touch panel attached (S11).

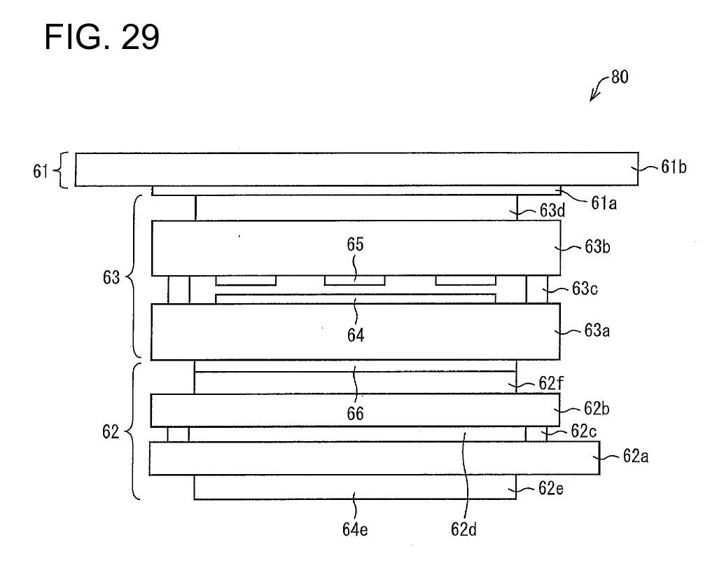

FIG. 29 shows an example of a 3D liquid crystal display device 80 including a touch panel.

As shown, besides the touch panel 61 and the liquid crystal panel 62, the 3D liquid crystal display device 80 includes a switching liquid layer panel 63 between the touch panel 61 and the liquid crystal panel 62.

The switching liquid layer panel 63 has a lower switching substrate 63a and an upper switching substrate 63b bonded together by a sealing material 63c, and a liquid crystal layer is provided between the two substrates.

On the lower switching substrate 63a, a common electrode 64 is formed on the surface thereof in contact with the liquid crystal layer, while on the upper switching substrate 63b, a common electrode 64 is formed and a plurality of segment electrodes 65 are formed on the surface thereof in contact with the liquid crystal layer.

On the upper switching substrate 63b, a polarizing plate 63d is provided on the surface in contact with the touch panel 61, and on the lower switching substrate 63a, an adhesive layer 66 is formed on the surface in contact with the liquid crystal panel 62.

The switching liquid crystal panel 63 has the function of alternately displaying at a prescribed period a right-side image and a left-side image exhibiting binocular disparity therebetween and displayed by the liquid crystal panel 62.

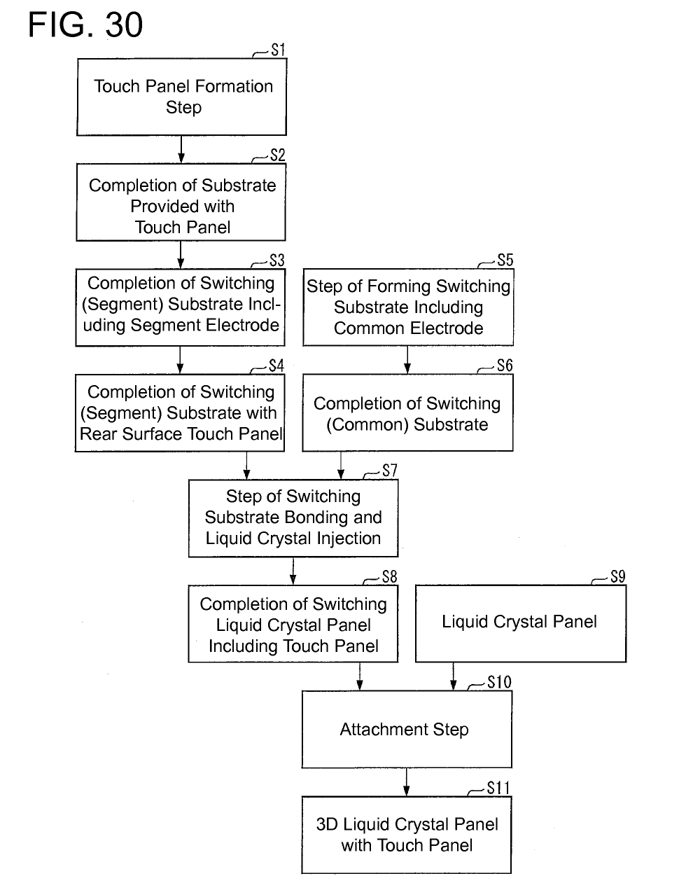

FIG. 30 shows one example of manufacturing steps for the 3D liquid crystal display device 80 including the touch panel shown in FIG. 29.

First, the plurality of films 61a are formed on the substrate 61b (S1), and the substrate including the touch panel is completed (S2).

Then, on the upper switching substrate 63b, the plurality of segment electrodes 65 are formed on the surface thereof in contact with the liquid crystal layer (S3).

Then, after the polarizing plate 63d is provided on the surface of the upper switching substrate 63b opposite to that in contact with the liquid crystal layer, the substrate 61b upon which the plurality of films 61a are formed is bonded onto the polarizing plate 63d, and the upper switching substrate 63b having a touch panel on the rear surface thereof is completed (S4).

Meanwhile, a common electrode 64 is formed on the surface of the lower switching substrate 63a in contact with the liquid crystal layer (S5), and the lower switching substrate 63a having the common electrode 64 formed thereon is completed (S6).

Then, the lower switching substrate 63a and the upper switching substrate 63b are bonded together and liquid crystal is injected (S7), and the switching liquid crystal panel 63 including the touch panel 61 is completed (S8).

Meanwhile, the liquid crystal panel 62 is completed by a conventional manufacturing method for a liquid crystal panel (S9).

Then, the switching liquid crystal panel 63 including the liquid crystal panel 62 and the touch panel 61 are bonded together with an adhesive layer 66 (S10), and the 3D liquid crystal display device 80 including the touch panel is completed (S11).

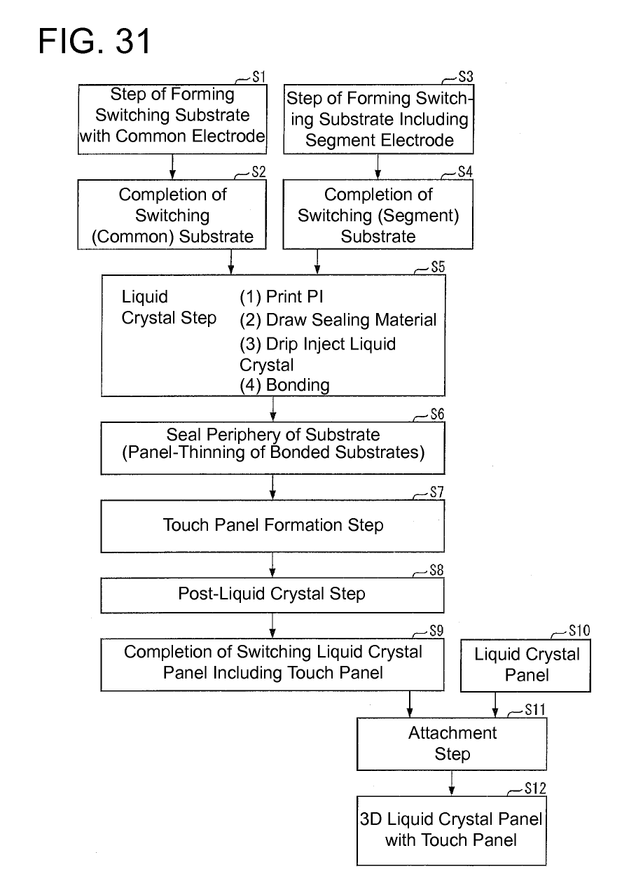

FIG. 31 shows one example of manufacturing steps for the 3D liquid crystal display device 80 including the touch panel shown in FIG. 29 but with a thinned configuration.

First, on the lower switching substrate 63a, the common electrode 64 is formed on the surface thereof in contact with the liquid crystal layer (S1), and the lower switching substrate 63a having formed thereon the common electrode 64 is completed (S2).

Meanwhile, on the upper switching substrate 63b, a plurality of segment electrodes 65 are formed on the surface thereof in contact with the liquid crystal layer (S3), and the upper switching substrate 63b having the plurality of segment electrodes 65 formed thereon is completed (S4).

A pre-liquid crystal step (S5) including the steps of printing alignment films (PI) on the respective substrates, and bonding the substrates together after the sealing material is drawn and liquid crystal drip injected on one of the substrates is performed.

Then a panel thinning step is performed on both substrates (S6) in which the periphery of the bonded substrates is sealed.

Then, the plurality of films 61a are formed on the substrate 61b (S7), and a post-liquid crystal step (S8) is performed in which the polarizing plate 63d is attached to the surface of the upper switching substrate 63b or lower switching substrate 63a opposite to the surface in contact with the liquid crystal layer.

Then, the touch panel 61 and the switching liquid crystal panel 63 are attached, and the switching liquid crystal panel 63 including the touch panel 61 is completed (S9).

Meanwhile, the liquid crystal panel 62 is completed by a conventional manufacturing method for a liquid crystal panel (S10).

Then, the switching liquid crystal panel 63 including the liquid crystal panel 62 and the touch panel 61 are bonded together (S11), and the 3D liquid crystal display device 80 including the thinned touch panel is completed (S12).

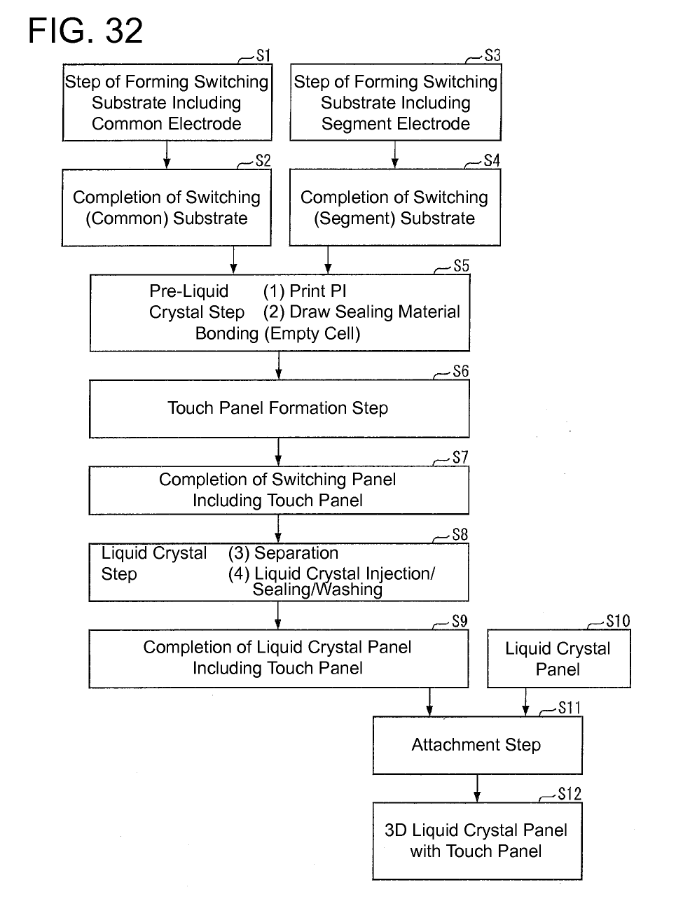

FIG. 32 shows another example of manufacturing steps for the 3D liquid crystal display device 80 including the touch panel shown in FIG. 29.

First, on the lower switching substrate 63a, the common electrode 64 is formed on the surface thereof in contact with the liquid crystal layer (S1), and the lower switching substrate 63a having formed thereon the common electrode 64 is completed (S2).

Meanwhile, on the upper switching substrate 63b, a plurality of segment electrodes 65 are formed on the surface thereof in contact with the liquid crystal layer (S3), and the upper switching substrate 63b having the plurality of segment electrodes 65 formed thereon is completed (S4).

Then, a pre-liquid crystal step is performed in which alignment films (PI) are printed on the respective substrates, the sealing material is drawn on either of the substrates, and the substrates are bonded together, thus forming an empty cell (S5).

Then, the plurality of films 61a are formed on the substrate 61b (S6), and the polarizing plate 63d is attached to the surface of the upper switching substrate 63b or the lower switching substrate 63a opposite to the surface thereof in contact with the liquid crystal layer, and the touch panel 61 and the switching liquid crystal panel 63 are bonded together, thus completing the switching liquid crystal panel 63 including the touch panel 61 (S7).

Then a liquid crystal step is performed in which the empty cell is separated, and liquid crystal injection, sealing, and washing are performed (S8).

Then, the polarizing plate 63d is attached to the surface of the upper switching substrate 63b or the lower switching substrate 63a opposite to the surface thereof in contact with the liquid crystal layer, and the touch panel 61 and the switching liquid crystal panel 63 are bonded together, thus completing the switching liquid crystal panel 63 including the touch panel 61 (S9).

Meanwhile, the liquid crystal panel 62 is completed by a conventional manufacturing method for a liquid crystal panel (S10).

Then, the switching liquid crystal panel 63 including the liquid crystal panel 62 and the touch panel 61 are bonded together (S11), and the 3D liquid crystal display device 80 including the touch panel is completed (S12).

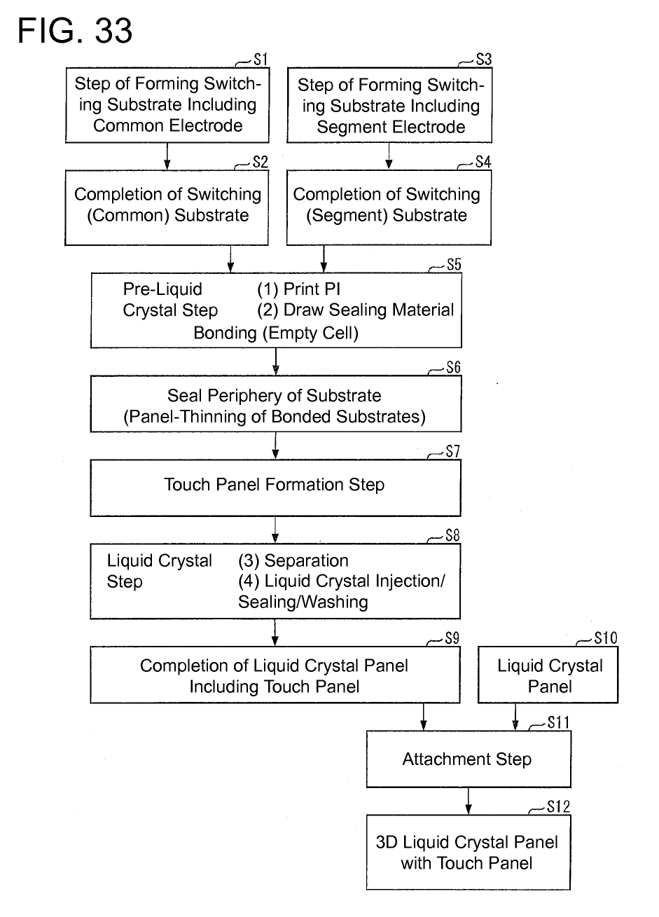

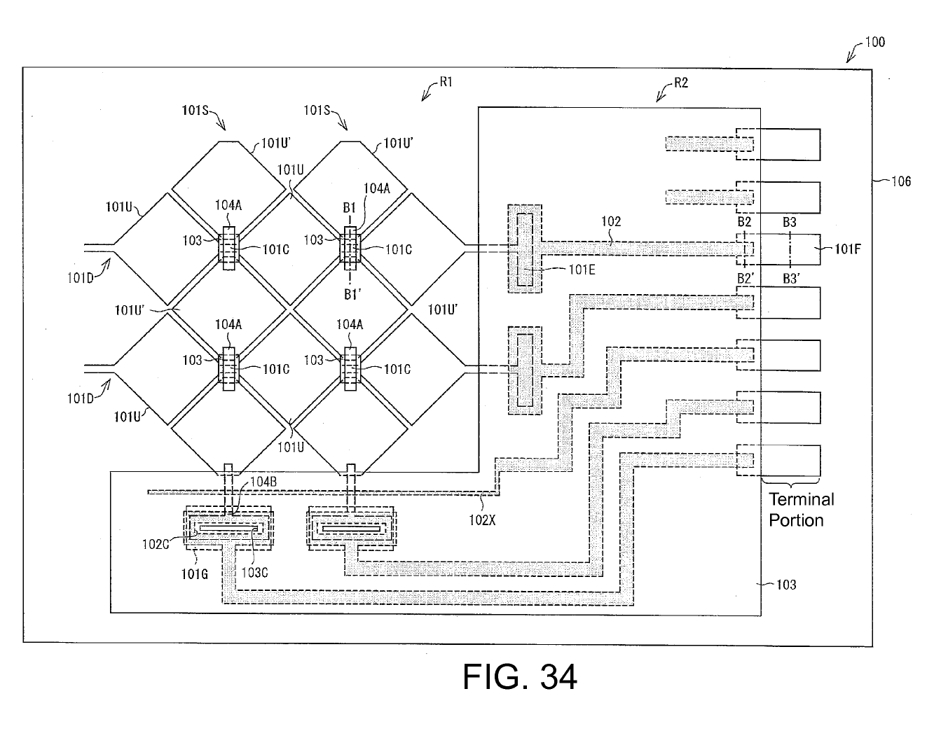

FIG. 33 shows another example of manufacturing steps for the 3D liquid crystal display device 80 including the touch panel shown in FIG. 29, but with a thinned configuration.

First, on the lower switching substrate 63a, the common electrode 64 is formed on the surface thereof in contact with the liquid crystal layer (S1), and the lower switching substrate 63a having formed thereon the common electrode 64 is completed (S2).

Meanwhile, on the upper switching substrate 63b, a plurality of segment electrodes 65 are formed on the surface thereof in contact with the liquid crystal layer (S3), and the upper switching substrate 63b having the plurality of segment electrodes 65 formed thereon is completed (S4).

Then, a pre-liquid crystal step is performed in which alignment films (PI) are printed on the respective substrates, the sealing material is drawn on either of the substrates, and the substrates are bonded together, thus forming an empty cell (S5).

Then a panel thinning step is performed on both substrates (S6) in which the periphery of the empty cell is sealed.

Then, the plurality of films 61a are formed on the substrate 61b, thus forming the touch panel 61 (S7).

Then a liquid crystal step is performed in which the empty cell is separated, and liquid crystal injection, sealing, and washing are performed (S8).

Then, the polarizing plate 63d is attached to the surface of the upper switching substrate 63b or the lower switching substrate 63a opposite to the surface thereof in contact with the liquid crystal layer, and the touch panel 61 and the switching liquid crystal panel 63 are bonded together, thus completing the switching liquid crystal panel 63 including the touch panel 61 (S9).

Meanwhile, the liquid crystal panel 62 is completed by a conventional manufacturing method for a liquid crystal panel (S10).

Then, the switching liquid crystal panel 63 including the liquid crystal panel 62 and the touch panel 61 are bonded together (S11), and the 3D liquid crystal display device 80 including the touch panel is completed (S12).

In the present embodiment, a liquid crystal display device including a touch panel was described as an example, but the type of display portion is not limited to a liquid crystal panel, and naturally may be an organic EL display device or the like including a touch panel, for example.

It is preferable that the insulating layer in the touch panel of the present invention be an organic insulating layer.

Because of the configuration above, the insulating layer formed on the metal wiring lines is an organic insulating layer, and thus, there is no need to form the metal wiring lines in a tapered shape, which means that the tapered shape of the metal wiring lines need not be a sequential tapered shape, which means that there is no special limitation on the tapered shape of the metal wiring lines.

Also, if the insulating layer is an organic insulating layer, it is more susceptible to moisture entering, and thus, the conductive protective layer is more suitable to preventing the entry of moisture.

It is preferable that the conductive protective layer of the touch panel of the present invention be formed so as to cover all of the respective metal wiring lines.

According to this configuration, the conductive protective layer can prevent the entry of moisture more efficiently, and thus, it is possible to mitigate the corrosion and deterioration of the metal wiring lines.

It is preferable that the touch panel of the present invention further include a relay electrode electrically connected to one of the plurality of metal wiring lines, the insulating layer being formed on the relay electrode, the conductive protective layer including a plurality of electrically separate films of a prescribed shape that each covers an individual metal wiring line, the relay electrode and either the first electrode or the second electrode being electrically connected by one of the films of a prescribed shape of the conductive protective layer through a first penetrating hole formed in the insulating layer over the relay electrode.

In a touch panel of the present invention, it is preferable that the relay electrode and the one of the metal wiring lines be electrically connected such that the one of the metal wiring lines is in contact with the relay electrode, on the relay electrode, that the metal wiring line provided on the relay electrode have formed thereover a first penetrating hole and a second penetrating hole overlapping at least a portion of the metal wiring line in a plan view in the insulating layer, and that the relay electrode and at least either of the first electrodes and the second electrodes be electrically connected by the conductive protective layer through the first penetrating hole and the second penetrating hole.

According to this configuration, the conductive protective layer can mitigate the corrosion and deterioration of the metal wiring lines, and also, it is possible to electrically connect the metal wiring lines to either the first electrodes or the second electrodes.

It is preferable that the conductive protective layer of the touch panel of the present invention be formed of the same layer by which the first connecting portions are formed.

According to this configuration, it is possible to form the conductive protective layer of the layer by which the unit electrodes of the first electrodes are formed, the layer by which the unit electrodes of the second electrodes are formed, and the layer by which the first connecting portions, which are generally formed in the layer above that by which the second connecting portions are formed, are formed.

In the touch panel of the present invention, it is preferable that the layer by which the first connecting portions are formed and the layer by which the metal wiring lines are formed be the same layer.

According to this configuration, the first connecting portions are formed of the same layer as the metal wiring lines and thus, it is possible to reduce the resistance of the first connecting portions.

In the touch panel of the present invention, it is preferable that the metal wiring lines be formed so as to be in contact with the first electrodes or the second electrodes.

According to this configuration, it is possible to reduce the number of manufacturing steps compared to a conventional configuration despite the conductive protective layer being included.

It is preferable that the insulating layer in the touch panel of the present invention be made of a material that absorbs visible light.

According to this configuration, even if the first connecting portions are formed of the same layer as the metal wiring lines, it is possible to prevent the appearance of patterns of the first connecting portions.

In the touch panel of the present invention, it is preferable that the conductive protective layer include a first conductive protective layer that covers all of the respective metal wiring lines electrically connected to the first electrodes, and a second conductive protective layer that covers all of the respective metal wiring lines electrically connected to the second electrodes, that the first conductive protective layer be electrically separate from the second conductive protective layer, and that the first conductive protective layer and the second conductive protective layer be respectively grounded.

According to this configuration, it is possible to attain a touch panel with improved capacitive touch functionality.

In the touch panel of the present invention, it is preferable that a black matrix layer made of metal be formed either in a layer above or a layer below the first connecting portion such that at least a portion of the black matrix layer overlaps the first connecting portion in a plan view.

According to this configuration, even if the first connecting portions are formed of the same layer as the metal wiring lines, it is possible to prevent the appearance of patterns of the first connecting portions.

In the touch panel of the present invention, it is preferable that the black matrix layer made of metal be formed into a prescribed shape in a frame region on the insulating substrate.

According to this configuration, it is possible to form the black matrix region in the frame portion of the touch panel with relative ease.

In a display device of the present invention, it is preferable that the above-mentioned display panel be a liquid crystal panel that includes a liquid crystal layer.

In a display device of the present invention, it is preferable that the above-mentioned display panel be an organic electroluminescent panel that includes an organic electroluminescent layer.

The present invention is not limited to the embodiment described above, and various modifications can be made without departing from the scope of the claims. Therefore, embodiments obtained by appropriately combining the techniques disclosed in different embodiments are included in the technical scope of the present invention.

### INDUSTRIAL APPLICABILITY

The present invention can be suitably used in a touch panel and a display device including a touch panel.

### DESCRIPTION OF REFERENCE CHARACTERS

1 touch panel
2 conductive protective layer
3 conductive protective layer
4A, 4B, 4C conductive protective layer
5 interlayer insulating layer made of black resin
5C contact hole (penetrating hole)
6 conductive protective layer
7 black matrix layer made of metal
8 conductive protective layer
10 touch panel
20 touch panel
30 touch panel
40 touch panel
50 touch panel
60 liquid crystal display device (display device)
70 liquid crystal display device (display device)
80 liquid crystal display device (display device)
101D drive electrode line (first electrode, second electrode)
101S sensing electrode line (first electrode, second electrode)
101U, 101U′ unit electrode
101C connecting portion (second connecting portion)
101E connecting electrode
101F terminal portion
101G relay electrode
101H ground wiring line connecting electrode
101I connecting electrode
101J connecting electrode
102 metal wiring line
102C contact hole (second penetrating hole)
102X ground wiring line
103 interlayer insulating layer
103C contact hole (first penetrating hole)
104A first bridge electrode (first connecting portion)
104B second bridge electrode
104C relay electrode
104D ground wiring line connecting electrode
104E relay electrode

1. A touch panel, comprising a plurality of first electrodes aligned in a first direction and a plurality of second electrodes aligned in a second direction different from the first direction, the plurality of first electrodes and the plurality of second electrodes intersecting each other on an insulating substrate and being electrically connected to respective terminal portions through respective metal wiring lines,
wherein the plurality of first electrodes and the plurality of second electrodes are electrically separate from each other,
wherein the respective first electrodes and second electrodes are formed by having a plurality of unit electrodes of a prescribed shape electrically connected to each other,
wherein the unit electrodes of the first electrodes and the unit electrodes of the second electrodes are formed on the same plane so as to be adjacent to each other without overlapping in a plan view,
wherein each of the first electrodes has first connecting portions that electrically connect adjacent unit electrodes, and the first connecting portions are formed in a layer different from that of the unit electrodes of the first electrodes and the unit electrodes of the second electrodes,
wherein each of the second electrodes has second connecting portions that electrically connect adjacent unit electrodes, and the second connecting portions are formed in a layer different from that of the first connecting portions, and
wherein the touch panel further comprises:
an insulating layer provided between the first connecting portions and the second connecting portions at intersections between the first electrodes and the second electrodes, and provided so as to cover the metal wiring lines; and
a conductive protective layer formed in a layer over the metal wiring lines across the insulating layer such that at least a portion thereof covers the metal wiring lines in a plan view, the conductive protective layer being formed of a layer by which the unit electrodes of the first electrodes are formed, a layer by which the unit electrodes of the second electrodes are formed, a layer by which the first connecting portions are formed, a layer by which the second connecting portions are formed, or a layer by which the terminal portions are formed.

2. The touch panel according to claim 1, wherein the insulating layer is an organic insulating layer.

3. The touch panel according to claim 1, wherein the conductive protective layer is formed so as to cover all of the respective metal wiring lines.

4. The touch panel according to claim 1, further comprising relay electrodes electrically connected to one of the plurality of metal wiring lines,
wherein the insulating layer is formed on the relay electrodes,
wherein the conductive protective layer includes a plurality of electrically separate films of a prescribed shape that each covers an individual metal wiring line among the metal wiring lines, and
wherein the relay electrodes and either the first electrodes or the second electrodes are electrically connected by one of the films of a prescribed shape of the conductive protective layer through a first penetrating hole formed in the insulating layer over the relay electrodes.

5. The touch panel according to claim 4,
wherein the relay electrodes and said one of the metal wiring lines are electrically connected such that the one of the metal wiring lines is in contact with the relay electrodes while being on said relay electrodes,
wherein the metal wiring line provided on the relay electrodes has formed thereover a first penetrating hole and a second penetrating hole overlapping at least a portion of the metal wiring line in a plan view in the insulating layer, and
wherein the relay electrodes and at least either of the first electrodes and the second electrodes are electrically connected by the conductive protective layer through the first penetrating hole and the second penetrating hole.

6. The touch panel according to claim 1, wherein the conductive protective layer is formed of the same layer by which the first connecting portions are formed.

7. The touch panel according to claim 1, wherein the layer by which the first connecting portions are formed and the layer by which the metal wiring lines are formed are the same layer.

8. The touch panel according to claim 7, wherein the metal wiring lines are formed so as to be in contact with the first electrodes or the second electrodes.

9. The touch panel according to claim 1, wherein the insulating layer is made of a material that absorbs visible light.

10. The touch panel according to claim 1,
wherein the conductive protective layer includes a first conductive protective layer that covers all of the respective metal wiring lines electrically connected to the first electrodes, and a second conductive protective layer that covers all of the respective metal wiring lines electrically connected to the second electrodes,
wherein the first conductive protective layer is electrically separate from the second conductive protective layer, and
wherein the first conductive protective layer and the second conductive protective layer are respectively grounded.

11. The touch panel according to claim 1, wherein a black matrix layer made of metal is formed either in a layer above or a layer below the first connecting portions such that at least a portion of the black matrix layer overlaps the first connecting portions in a plan view.

12. The touch panel according to claim 11, wherein the black matrix layer made of metal is formed into a prescribed shape in a frame region on the insulating substrate.

13. The display device, comprising the touch panel according to claim 1, and a display panel.

14. The display device according to claim 13, wherein the display panel is a liquid crystal panel including a liquid crystal layer.

15. The display device according to claim 13, wherein the display panel is an organic electroluminescent panel including an organic electroluminescent layer.
